(19) United States
(12) Patent Application Publication
(10) Pub. No.: US 2017/0075415 A1
(43) Pub. Date: Mar. 16, 2017

(54) ELECTRONIC DEVICE USING INFORMATION ON SKIN COLOR TYPE AND CONTROL METHOD THEREOF

(71) Applicant: Samsung Electronics Co., Ltd., Gyeonggi-do (KR)

(72) Inventors: Sook-Jin KIM, Gyeonggi-do (KR); Jong-Jin KIM, Gyeonggi-do (KR); Joon-Ho KIM, Gyeonggi-do (KR); Jin-Gil YANG, Gyeonggi-do (KR); Gih-Sung CHUNG, Gyeonggi-do (KR); Kyu-Youn HWANG, Seoul (KR); Hong-Sig KIM, Gyeonggi-do (KR); In-Ji JIN, Gyeonggi-do (KR)

(21) Appl. No.: 15/256,952

(22) Filed: Sep. 6, 2016

(30) Foreign Application Priority Data
Sep. 14, 2015 (KR) 10-2015-0129964

(51) Int. Cl. G06F 3/01; G06K 9/20; G06K 9/46; G06K 9/00

(52) U.S. Cl. CPC G06F 3/011; G06K 9/00362; G06K 9/2027; G06K 9/4652

(57) ABSTRACT

An electronic device and method that detects an event related to the user's skin and performs a function corresponding to the event by using information on the skin color type of the user, and further provides a control method thereof. The occurrence of an event is detected that is related to at least a part of a user's body. Information regarding a light is obtained a sensor module that is functionally connected with the electronic device according to the detection result. A function is performed that corresponds to the detected event by using information corresponding to the obtained information on a light from among type information stored in a memory.

### CLAIM OF PRIORITY

This application claims the benefit of priority under 35 U.S.C. §119(a) from Korean Application Serial No. 10-2015-0129964, which was filed in the Korean Intellectual Property Office on Sep. 14, 2015, the entire content of which is hereby incorporated by reference.

### BACKGROUND

Field of the Disclosure

The present disclosure relates to an electronic device that uses information on the skin color type of the user, and to a control method thereof. In particular, the embodiments relate to an electronic device for detecting an event related to a user's skin and for performing a function corresponding to the event by using skin color type information that is generated based on a signal received from a sensor module in response to the event and further relate to a control method thereof.

Description of the Related Art

Recently, wearable electronic devices have been rapidly developed. The wearable electronic devices may be worn on the user's body. The user may wear the electronic devices on his/her body, and may be easily provided with information that is output from the electronic devices. The wearable electronic device may include sensors that measure biometric signals from the human body. The sensors, for example, are configured to measure biometric signals, such as the heart rate or oxygen saturation of the user. The wearable electronic device may process and analyze the measured biometric signals in order to output information related to the user's body for monitoring purposes. The user may review the information related to the user's body from the wearable electronic device in order to recognize his/her own physical conditions.

With regard to the recognition of the user's physical conditions, a proper intensity of a current is required to accurately measure the heart rate of the user. The intensity of the current used for the measurement of the heart rate may vary depending on the user's skin color. In addition, the UV exposure allowance time, or the vitamin D synthesis time, may also be different for each person depending on the user's skin color. Meanwhile, it is possible to monitor the user's health conditions according to a change in the skin color of the user who uses the wearable electronic device.

Therefore, in order to provide accurate physical condition and health information to the user, there is a need to provide a wearable electronic device that collects physical condition and health information according to the skin color of individual users.

### SUMMARY

The present disclosure provides an electronic device that detects an event related to the user's skin and performs a function corresponding to the event by using information regarding a skin color type of the user, and further provides a control method thereof.

A control method of an electronic device, according to the embodiment of the present disclosure, may include: detecting an occurrence of an event that is related to at least a part of a user's body; obtaining information about a light from a sensor module that is functionally connected with the electronic device according to the detection result; and performing a function corresponding to the event by using information corresponding to the obtained information on the light among type information stored in a memory.

The obtaining of the information from the sensor module regarding the light may include obtaining the information regarding the light based on a first optical signal that is output from a light-emitting unit of the sensor module and second optical signal that is made by the first optical signal being received by a light-receiving unit of the sensor module through a user's skin.

The skin-type information may use at least one of a melanin index conversion information or a color space value information.

The detecting of the occurrence of an event may include transmitting, to the sensor module, a control signal for controlling the activation degree of the sensor module based on the event.

In the case where the event is an attachment/detachment event or the execution of a heart rate measurement application, the function corresponding to the event may include controlling the current intensity of the light-emitting unit of the sensor module.

In the case where the event is the occurrence of updating at least one of season information or weather information, the function corresponding to the event may include providing at least one of a UV exposure-related information or a vitamin D synthesis-related information with respect to the user's skin.

In the case where the event is the execution of a camera application, the function corresponding to the event may include generating a skin color correction information for the user's skin.

The obtaining of the information on the light from the sensor module may include: determining whether or not the sensor module is in contact with the user's skin; and obtaining the information on the light if the sensor module is in contact with the user's skin.

The method may further include: determining the skin color type of the user based on the light information; and storing the skin color type in the memory.

According to an embodiment of the present disclosure, an electronic device may include: a processor that controls the detection of the occurrence of an event that is related to at least a part of a user's body and controls the electronic device; a memory that stores type information; a sensor module that obtains information about a light that is generated through a user's skin under the control of the processor, wherein the processor performs a function corresponding to the event by using information corresponding to the obtained information about the light from among the type information stored in the memory.

The sensor module may include: a light-emitting unit that outputs a first optical signal; and a light-receiving unit that receives a second optical signal that is generated by the first optical signal passing through the user's skin, wherein the sensor module outputs the information about the light to the processor based on the first optical signal and the second optical signal.

The type information may use at least one of a melanin index conversion information or color space value information.

The processor may send a control signal to the sensor module, a control signal for controlling the activation degree of the sensor module based on the event.

In the case where the event is an attachment/detachment event or the execution of a heart rate measurement application, the function corresponding to the event may be controlling the current intensity of a light-emitting unit of the sensor module.

In the case where the event is the occurrence of updating at least one of season information or weather information, the function corresponding to the event may be providing at least one of UV exposure-related information or vitamin D synthesis-related information with respect to the user's skin.

In the case where the event is the execution of a camera application, the function corresponding to the event may be generating skin color correction information for the user's skin.

The electronic device may further include a detection module having circuitry configured to determine whether or not the sensor module comes is in contact with the user's skin, and the processor obtains the information about the light according to the determination result of the detection module.

The processor is configured to identify the skin color type of the user based on the information regarding the light, and stores the skin color type in the memory.

In another aspect of the present disclosure, a control method of an electronic device according to the embodiment of the present disclosure, may include: detecting whether the occurrence of an event is related to a skin of the first user; identifying whether or not a sensor module contacts the skin of the first user by a detection module according to the detection result; obtaining, from the sensor module, information regarding a light that is generated through the user's skin if the sensor module contacts the skin of the first user; generating a first skin color type information corresponding to the obtained information on the light among type information stored in a memory; comparing the first skin color type information with a second skin color type information stored in the memory; and storing the first skin color type information in the memory according to the comparing operation.

The identifying of the contact by the detection module may include determining whether or not the first user is the same as the second user (who may be predetermined).

The method may further include providing health status information of the first user based on the first skin color type information and on the second skin color type information.

A control method of an electronic device, according to the embodiment of the present disclosure, may include: detecting an occurrence of an event that uses the a predetermined skin color type of the first user; obtaining an actual skin color type of the first user; and performing a function corresponding to the event by using the obtained skin color type of the first user.

The obtaining of the actual skin color type of the first user may include obtaining the actual skin color type of the first user from other electronic devices.

The obtaining of the actual skin color type of the first user may include: analyzing an image that is obtained from the camera module included in the electronic device; and determining the skin color type of the first user by based on the analysis operation.

According to an embodiment of the present disclosure, in relation to the execution of a function corresponding to the event related to the user's skin, the control method of an electronic device can more efficiently obtain information about the skin color type of the user, and can more accurately execute the function corresponding to the event by using the skin color type information.

### BRIEF DESCRIPTION OF THE DRAWINGS

The detailed description of each drawing is provided in order to fully understand the drawings that are illustrated in the detailed description of the present disclosure, in which:

FIG. 1 is a block diagram of an electronic device and a network, according to various embodiments of the present disclosure;

FIG. 2 is a block diagram of an electronic device, according to various embodiments of the present disclosure;

FIG. 3 is an exemplary block diagram of a program module, according to various embodiments of the present disclosure;

FIG. 4 is a schematic block diagram of an electronic device, according to an embodiment of the present disclosure;

FIG. 5 is a data flow illustrating a control method of the electronic device shown in FIG. 4;

FIG. 6 is a schematic block diagram of an electronic device, according to another embodiment of the present disclosure;

FIG. 7A is a data flow illustrating various embodiments of a control method of the electronic device shown in FIG. 6;

FIG. 7B is a data flow illustrating various embodiments of a control method of the electronic device shown in FIG. 6;

FIG. 7C is a data flow illustrating various embodiments of a control method of the electronic device shown in FIG. 6;

FIG. 7D is a data flow illustrating various embodiments of a control method of the electronic device shown in FIG. 6;

FIG. 8 is a data flow illustrating a control method of the electronic device shown in FIGS. 4 and 6;

FIG. 9 is a table representing skin color type information that is stored in the second electronic device shown in FIG. 6;

FIG. 10 is a flowchart illustrating a control method of the electronic device, according to various embodiments of the present disclosure;

FIG. 11 is a flowchart illustrating a control method of the electronic device, according to various embodiments of the present disclosure;

FIG. 12 is a table showing type information related to the melanin index described in FIG. 11;

FIG. 13 is a flowchart illustrating a control method of the electronic device, according to various embodiments of the present disclosure;

FIG. 14 is a table showing type information related to the color space conversion described in FIG. 13;

FIG. 15 is a flowchart illustrating a control method of the electronic device, according to various embodiments of the present disclosure;

FIG. 16 is a flowchart illustrating a control method of the electronic device, according to various embodiments of the present disclosure;

FIG. 17 is a flowchart illustrating a control method of the electronic device, according to various embodiments of the present disclosure;

FIG. 18 is a flowchart illustrating a control method of the electronic device, according to various embodiments of the present disclosure;

FIG. 19 is a flowchart illustrating a control method of the electronic device, according to various embodiments of the present disclosure;

FIG. 20 is a table provide to illustrate a control method of the electronic device described in FIG. 19; and

FIG. 21 is a flowchart illustrating a control method of the electronic device, according to various embodiments of the present disclosure.

### DETAILED DESCRIPTION

Hereinafter, various embodiments of the present document will be described with reference to the accompanying drawings. However, it should be understood that the present disclosure is not limited to the particular forms disclosed herein; rather, the present disclosure should be construed to cover various modifications, equivalents, and/or alternatives of embodiments of the present disclosure. In describing the drawings, similar reference numerals may be used to designate similar constituent elements.

As used herein, the expression “have”, “may have”, “include”, or “may include” refers to the existence of a corresponding feature (e.g., numeral, function, operation, or constituent element such as component), and does not exclude one or more additional features.

In the present disclosure, the expression “A or B”, “at least one of A or/and B”, or “one or more of A or/and B” may include all possible combinations of the items listed. For example, the expression “A or B”, “at least one of A and B”, or “at least one of A or B” refers to all of (1) including at least one A, (2) including at least one B, or (3) including all of at least one A and at least one B.

The expression “a first”, “a second”, “the first”, or “the second” used in various embodiments of the present disclosure may modify various components regardless of the order and/or the importance but does not limit the corresponding components. For example, a first element may be termed a second element, and similarly, a second element may be termed a first element without departing from the scope of the present disclosure.

It should be understood that when an element (e.g., first element) is referred to as being (operatively or communicatively) “connected,” or “coupled,” to another element (e.g., second element), it may be directly connected or coupled directly to the other element or any other element (e.g., third element) may be interposer between them. In contrast, it may be understood that when an element (e.g., first element) is referred to as being “directly connected,” or “directly coupled” to another element (second element), there are no element (e.g., third element) interposed between them.

The expression “configured to” used in the present disclosure may be exchanged with, for example, “suitable for”, “designed to”, “adapted to”, “made to”, according to the situation. The term “configured to” may not necessarily imply “specifically designed to” in hardware. Alternatively, in some situations, the expression “device configured to” may be defined that the device, together with other devices or components, “performs”. For example, the phrase “processor adapted (or configured) to perform A, B, and C” can refer to a dedicated processor, (e.g., embedded processor) only for performing the corresponding operations or a generic-purpose processor (e.g., central processing unit (CPU) or application processor (AP)) that can perform the corresponding operations by executing one or more software programs stored in a memory device.

The terms used herein are merely for the purpose of describing particular embodiments and do not limit the scope of other embodiments unless expressly stated. As used herein, singular forms of terms may include plural forms as well unless the context clearly indicates otherwise. Unless defined otherwise, all terms used herein, including technical and scientific terms, have the same meaning as those commonly understood by a person skilled in the art to which the present disclosure pertains. Such terms as those defined in a generally used dictionary may be interpreted to have the meanings equal to the contextual meanings in the relevant field of art, and are not to be interpreted to have ideal or excessively formal meanings unless clearly defined in the present disclosure. In some cases, even the term defined in the present disclosure should not be interpreted to exclude embodiments of the present disclosure.

An electronic device according to various embodiments of the present disclosure may include at least one of, for example, a smart phone, a tablet Personal Computer (PC), a mobile phone, a video phone, an electronic book reader (e-book reader), a desktop PC, a laptop PC, a netbook computer, a workstation, a server, a Personal Digital Assistant (PDA), a Portable Multimedia Player (PMP), a MPEG-1 audio layer-3 (MP3) player, a mobile medical device, a camera, and a wearable device. According to various embodiments, the wearable device may include at least one of an accessory type (e.g., a watch, a ring, a bracelet, an anklet, a necklace, a glasses, a contact lens, or a Head-Mounted Device (HMD)), a fabric or clothing integrated type (e.g., an electronic clothing), a body-mounted type (e.g., a skin pad, or tattoo), and a bio-implantable type (e.g., an implantable circuit).

According to some embodiments of the present disclosure, the electronic device may be a home appliance. The home appliance may include at least one of, for example, a television, a Digital Video Disk (DVD) player, an audio, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ and PlayStation™), an electronic dictionary, an electronic key, a camcorder, and an electronic photo frame.

According to another embodiment of the present disclosure, the electronic device may include at least one of various medical devices (e.g., various portable medical measuring devices (a blood glucose monitoring device, a heart rate monitoring device, a blood pressure measuring device, a body temperature measuring device, etc.), a Magnetic Resonance Angiography (MRA), a Magnetic Resonance Imaging (MRI), a Computed Tomography (CT) machine, and an ultrasonic machine), a navigation device, a Global Positioning System (GPS) receiver, an Event Data Recorder (EDR), a Flight Data Recorder (FDR), a Vehicle Infotainment Devices, an electronic devices for a ship (e.g., a navigation device for a ship, and a gyro-compass), avionics, security devices, an automotive head unit, a robot for home or industry, an automatic teller's machine (ATM) in banks, point of sales (POS) in a shop, or internet device of things (e.g., a light bulb, various sensors, electric or gas meter, a sprinkler device, a fire alarm, a thermostat, a streetlamp, a toaster, a sporting goods, a hot water tank, a heater, a boiler, etc.).

According to some embodiments of the present disclosure, the electronic device may include at least one of a part of furniture or a building/structure, an electronic board, an electronic signature receiving device, a projector, and various types of measuring instruments (e.g., a water meter, an electric meter, a gas meter, and a radio wave meter). The electronic device according to various embodiments of the present disclosure may be a combination of one or more of the aforementioned various devices. The electronic device according to some embodiments of the present disclosure may be a flexible device. Further, the electronic device according to an embodiment of the present disclosure is not limited to the aforementioned devices, and may include a new electronic device according to the development of technology.

Hereinafter, an electronic device according to various embodiments of the present disclosure will be described with reference to the accompanying drawings. In the present disclosure, the term “user” may indicate a person using an electronic device or a device (e.g., an artificial intelligence electronic device) using an electronic device.

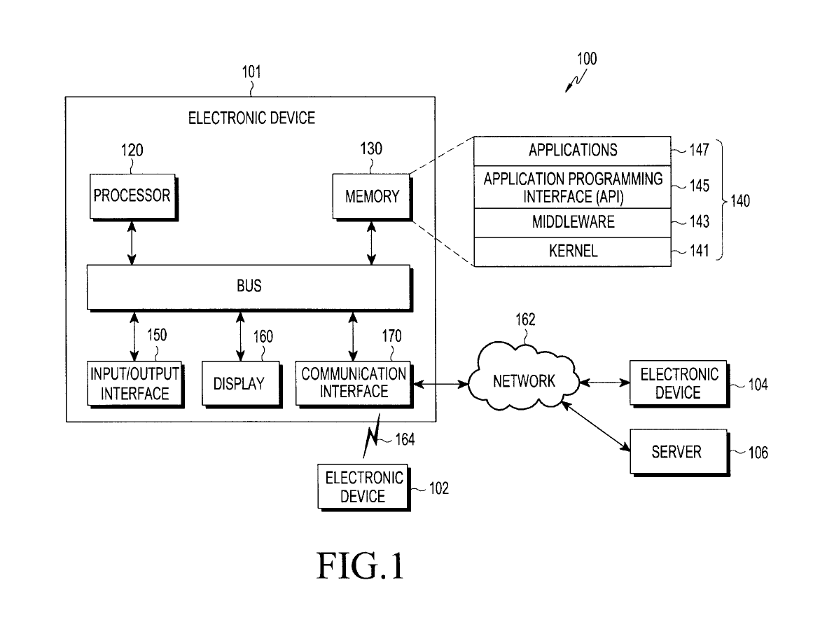

Referring now to FIG. 1, an electronic device 101 in the network environment 100 is disclosed, according to various embodiments of the present disclosure. The electronic device 101 may include a bus 110, a processor 120, a non-transitory memory 130, an input/output interface 150, a display 160, and a communication interface 170. In some embodiments, the electronic device 101 may exclude one or more elements or may add other elements thereto.

The bus 110, for example, may include a circuit for electrically connecting the elements 110 to 170 with each other and transferring communication data (e.g., control messages and/or data) between the elements.

The processor 120, which includes hardware such as circuitry configured for operation. may include at least one of a central processing unit, an application processor, or a communication processor (CP). The processor 120, for example, may process a calculation or data related to the control and/or communication of one or more other elements of the electronic device 101.

The memory 130 may include a volatile and/or non-volatile memory. For example, the memory 130 may store commands or data related to one or more other elements of the electronic device 101. According to an embodiment of the present disclosure, the memory 130 may store software and/or programs 140. For example, the programs 140 may include a kernel 141, middleware 143, an application programming interface (API) 145, and/or application programs (or “applications”) 147. At least some of the kernel 141, the middleware 143, or the API 145 may be referred to as an operating system.

The kernel 141 may control or manage system resources (for example, the bus 110, the processor 120, or the memory 130), which are used to execute the operation or function that is implemented in other programs (for example, the middleware 143, the API 145, or the application programs 147). In addition, the kernel 141 may provide an interface by which the middleware 143, the API 145, or the application programs 147 may access each element of the electronic device 101 to control or manage the system resources.

The middleware 143, for example, may play the intermediate role between the API 145 or the application programs 147 and the kernel 141 to communicate with each other for the transmission and reception of data.

In addition, the middleware 143 may process one or more operation requests that are received from the application programs 147 according to the priority. For example, the middleware 143 may give priority for using the system resources (for example, the bus 110, the processor 120, or the memory 130) of the electronic device 101 to one or more application programs 147. For example, the middleware 143 may perform scheduling or load-balancing for the one or more operation requests by processing the one or more operation requests according to the priority given to the one or more application programs 147.

With continued reference to FIG. 1, the API 145 may be an interface by which the application programs 147 control functions that are provided by the kernel 141 or the middleware 143, and, for example, may include one or more interfaces or functions (e.g., commands) for file control, window control, image processing, or text control.

The input/output interface 150 may serve as an interface to transfer commands or data received from the user or other external devices to other elements of the electronic device 101. In addition, the input/output interface 150 may output commands or data received from the other elements of the electronic device 101 to the user or the other external devices.

The display 160, for example, may include a liquid crystal display (LCD), a light-emitting diode (LED) display, an organic light-emitting diode (OLED) display, a micro electromechanical system (MEMS) display, an electronic paper display, or the like. For example, the display 160 may display a variety of content (e.g., text, images, videos, icons, and/or symbols) to the user. The display 160 may include a touch screen, and, for example, may receive a touch input, a gesture input, a proximity input, or a hovering input by using electronic pens or a user's body part.

The communication interface 170, for example, may configure communication between the electronic device 101 and external devices (e.g., the first external electronic device 102, the second external electronic device 104, or a server 106). For example, the communication interface 170 may be connected to the network 162 through wireless communication or wired communication in order to communicate with the external devices (e.g., the second external electronic device 104 or the server 106).

For example, the wireless communication may use, as a cellular communication protocol, at least one of LTE (long-term evolution), LTE-A (LTE Advance), CDMA (code division multiple access), WCDMA (wideband CDMA), a UMTS (universal mobile telecommunications system), WiBro (Wireless Broadband), GSM (Global System for Mobile Communications), or the like. In addition, the wireless communication, for example, may include short-range communication 164. The short-range communication 164 may include at least one of WiFi (wireless fidelity), Bluetooth, NFC (near field communication), or a GNSS (global navigation satellite system). The GNSS, for example, may include a GPS (global positioning system), a Glonass (global navigation satellite system), the Beidou Navigation Satellite System (hereinafter, “Beidou”), the Galileo, or the European global satellite based navigation system, according to the usage region or bandwidth. Hereinafter, “GPS” may be interchangeably used with “GNSS” in the present document. For example, the wired communication may include at least one of a USB (universal serial bus), an HDMI (high definition multimedia interface), RS-232 (recommended standard 232), or a POTS (plain old telephone service). The network 162 may include at least one of telecommunication networks, such as a computer network (e.g., LAN or WAN), the Internet, or a telephone network.

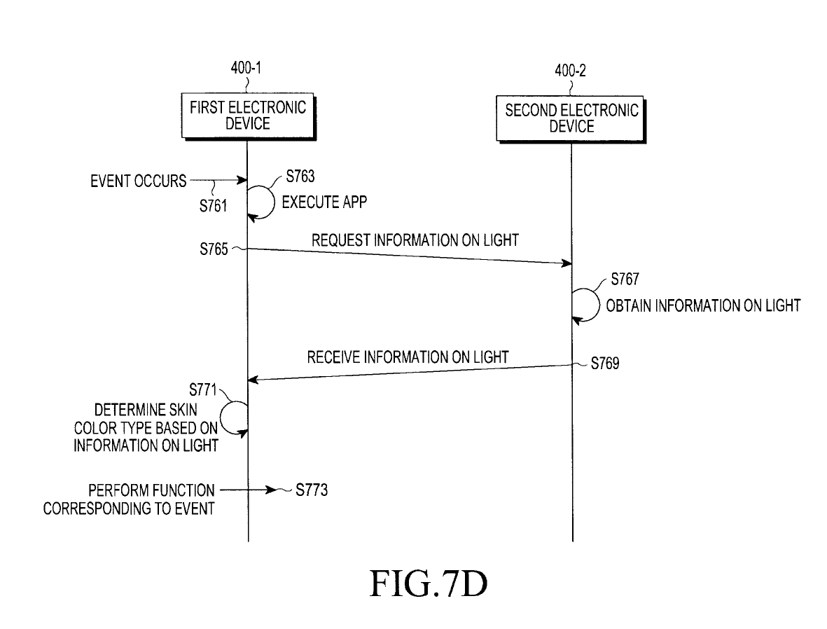

With continued reference to FIG. 10, the first external electronic device 102 and the second external electronic device 104 may be the same as, or different from, the electronic device 101 in its type. According to an embodiment, the server 106 may include a group of one or more servers. According to various embodiments of the present disclosure, all or some of the operations that are executed in the electronic device 101 may be executed by one or more other external devices (e.g., the electronic devices 102 and 104, or the server 106). According to an embodiment of the present disclosure, in the case where the electronic device 101 executes a specific function or service automatically or by request, the electronic device 101 may make a request to other external devices (e.g., the electronic devices 102 and 104, or the server 106) for at least some of the functions related to the same additionally or instead of executing the same by itself. The other electronic devices (e.g., the electronic devices 102 and 104, or the server 106) may execute the requested function or additional functions, and may deliver the result thereof to the electronic device 101. The electronic device 101 may provide the requested function or service by providing the received result or by additionally processing the same. To this end, for example, cloud computing, distributed computing, or client-server computing technology may be used.

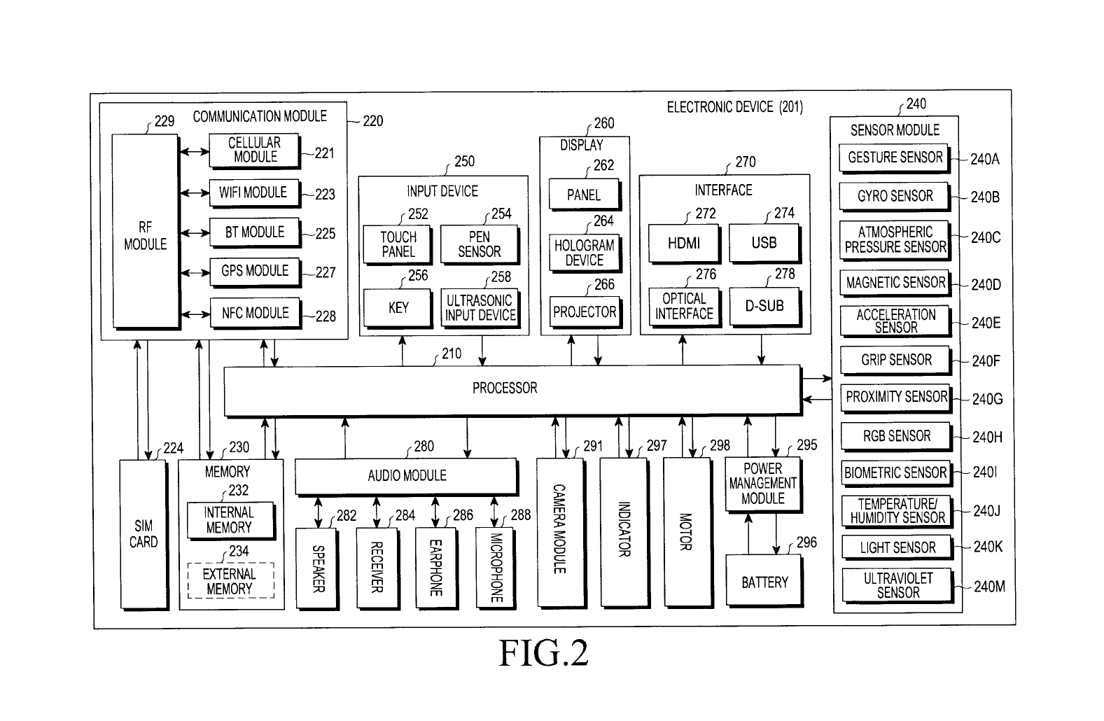

FIG. 2 is a block diagram of an electronic device 201, according to various embodiments of the present disclosure. The electronic device 201, for example, may include all or some of the electronic device 101 shown in FIG. 1. The electronic device 201 may include one or more processors {e.g., application processors (APs)} 210, a communication module 220, a subscriber identification module 224, a memory 230, a sensor module 240, an input device 250, a display 260, an interface 270, an audio module 280, a camera module 291, a power management module 295, a battery 296, an indicator 297, and a motor 298.

The processor 210, for example, which includes hardware such as integrated circuitry configured for operation, may control a multitude of hardware or software elements connected with the processor 210, and may perform the processing of various pieces of data and a calculation by driving an operating system or application programs. The processor 210 may be implemented by, for example, a system-on-chip (SoC). According to an embodiment of the present disclosure, the processor 210 may further include a graphic processing unit (GPU) and/or an image signal processor. The processor 210 may include at least some (e.g., the cellular module 221) of the elements shown in FIG. 2. The processor 210 may load commands or data received from one or more other elements (e.g., a non-volatile memory) to a volatile memory to then process the same, and may store a variety of data in a non-volatile memory.

The communication module 220 may have the same or a similar configuration as the communication interface 170 of FIG. 1. The communication module 220, for example, may include a cellular module 221, a WiFi module 223, a Bluetooth module 225, a GNSS module 227 (e.g., a GPS module, a Glonass module, a Beidou module, or a Galileo module), an NFC module 228, and an RF module 229, and can include hardware for transmission and reception, such as a transmitter, receiver, transceiver, one or more antennas, codecs.

The cellular module 221, for example, may provide voice calls, video calls, a text service, or the Internet service through communication networks. According to an embodiment, the cellular module 221 may perform identification and verification of the electronic device 201 in communication networks by using the subscriber identification module (e.g., a SIM card) 224. According to an embodiment, the cellular module 221 may perform at least some of the functions provided by the processor 210. According to an embodiment, the cellular module 221 may include a communication processor (CP).

The WiFi module 223, the Bluetooth module 225, the GNSS module 227, or the NFC module 228 may include a processor for processing data that is transmitted and received through the corresponding module, respectively. According to another embodiment, at least some (e.g., two or more) of the cellular module 221, the WiFi module 223, the Bluetooth module 225, the GNSS module 227, or the NFC module 228 may be included in one integrated chip (IC) or one IC package.

The RF module 229, for example, may transmit and receive communication signals (e.g., RF signals). The RF module 229 may include, for example, a transceiver, a power amp module (PAM), a frequency filter, a low noise amplifier (LNA), antennas, or the like. According to another embodiment, at least one of the cellular module 221, the WiFi module 223, the Bluetooth module 225, the GNSS module 227, or the NFC module 228 may transmit and receive RF signals through separated RF modules.

The subscriber identification module 224, for example, may include a card and/or an embedded SIM, which adopts a subscriber identification module, and may include inherent identification information {e.g., an integrated circuit card identifier (ICCID)} or subscriber information {e.g., an international mobile subscriber identity (IMSI)}.

The memory 230 (e.g., the memory 130) may include an internal memory 232 or an external memory 234. The internal memory 232, for example, may include at least one of volatile memories {e.g., a dynamic RAM (DRAM), a static RAM (SRAM), a synchronous dynamic RAM (SDRAM), or the like} or non-volatile memories {e.g., an one-time programmable ROM (OTPROM), a programmable ROM (PROM), an erasable and programmable ROM (EPROM), an electrically erasable and programmable ROM (EEPROM), a mask ROM, a flash ROM, a flash memory (e.g., NAND flash or NOR flash), a hard drive, a solid state drive (SSD), or the like}.

The external memory 234 may include a flash drive, which may be, for example, compact flash (CF), secure digital (SD), Micro SD, Mini SD, extreme digital (xD), a multi-media card (MMC), a memory stick, or the like. The external memory 234 may be functionally and/or physically connected with the electronic device 201 through various interfaces.

The sensor module 240, for example, may measure physical quantities or may detect the operation state of the electronic device 201 to convert the measured or detected information to electric signals. The sensor module 240 may include at least one of, for example, a gesture sensor 240A, a gyro sensor 240B, an air-pressure sensor 240C, a magnetic sensor 240D, an acceleration sensor 240E, a grip sensor 240F, a proximity sensor 240G, a color sensor 240H {e.g., a red green blue (RGB) sensor}, a biometric sensor 240I, a temperature/humidity sensor 240J, an illuminance sensor 240K, or an ultra violet (UV) sensor 240M. Alternatively or additionally, the sensor module 240, for example, may further include an E-nose sensor, an electromyography (EMG) sensor, an electroencephalogram (EEG) sensor, an electrocardiogram (ECG) sensor, an infrared (IR) sensor, an iris sensor, and/or a fingerprint sensor. The sensor module 240 may further include a control circuit for controlling one or more sensors included therein. In some embodiments, the electronic device 201 may further include a processor as a part of the processor 210 or separately from the processor 210, which is configured to control the sensor module 240 while the processor 210 is in a sleep mode.

The input device 250, for example, may include a touch panel 252, a (digital) pen sensor 254, keys 256, or an ultrasonic input device 258. The touch panel 252 may use at least one of, for example, a capacitive type, a pressure sensitive type, an infrared type, or an ultrasonic type. In addition, the touch panel 252 may further include a control circuit. The touch panel 252 may further include a tactile layer in order to provide a user with a tactile reaction.

For example, the (digital) pen sensor 254 may be a part of the touch panel, or may include a separate recognition sheet. The keys 256 may include, for example, physical buttons, optical keys, or a keypad. The ultrasonic input device 258 may detect ultrasonic waves generated by input means through a microphone (e.g., a microphone 288) to identify data corresponding to the detected ultrasonic waves.

The display 260 (e.g., the display 160) may include a panel 262, a hologram device 264, or a projector 266. The panel 262 may include the same or a similar configuration as the display 160 of FIG. 1. The panel 262 may be implemented to be, for example, flexible, transparent, or wearable. The panel 262 may be configured with the touch panel 252 as one module. The hologram device 264 may display 3D images in the air by using interference of light. The projector 266 may display images by projecting light onto a screen. The screen may be positioned, for example, inside or outside the electronic device 201. According to an embodiment, the display 260 may further include a control circuit for controlling the panel 262, the hologram device 264, or the projector 266.

The interface 270 may include, for example, a high-definition multimedia interface (HDMI) 272, a universal serial bus (USB) 274, an optical interface 276, or a D-subminiature (D-sub) 278, just to name some non-limiting possibilities. The interface 270, for example, may be included in the communication interface 170 shown in FIG. 1. Additionally or alternatively, the interface 270 may include, for example, a mobile high-definition link (MHL) interface, a secure digital (SD) card/multi-media card (MMC) interface, or an infrared data association (IrDA) standard interface.

The audio module 280, for example, may convert a sound into an electric signal, and vice versa. At least some elements of the audio module 280, for example, may be included in the input/output interface 145 shown in FIG. 1. For example, the audio module 280 may process sound information that is inputted, or output, through a speaker 282, a receiver 284, earphones 286, or a microphone 288.

The camera module 291 is a device for photographing still and moving images, and, according to an embodiment of the present disclosure, the camera module 291 may include one or more image sensors (e.g., a front sensor or a rear sensor such as a CCD or CMOS), lenses, an image signal processor (ISP), or a flash (e.g., an LED or a xenon lamp).

The power management module 295, for example, may manage the power of the electronic device 201. According to an embodiment of the present disclosure, the power management module 295 may include a power management integrated circuit (PMIC), a charger integrated circuit (IC), or a battery or fuel gauge. The PMIC may be implemented by a wired charging type and/or a wireless charging type. The wireless charging type may encompass, for example, a magnetic resonance type, a magnetic induction type, or an electromagnetic wave type, and additional circuits for wireless charging (such as coil loops, resonance circuits, or rectifiers) may be provided. The battery gauge may measure, for example, the remaining power of the battery 296, a charging voltage and current, or temperature. The battery 296 may include, for example, a rechargeable battery and/or a solar battery.

The indicator 297 may display a specific state (for example, the booting state, the message state, or the charging state) of the electronic device 201 or a part thereof (e.g., the processor 210). The motor 298 may convert an electric signal to a mechanical vibration, and may generate a vibration or a haptic effect. Although it is not shown in the drawing, the electronic device 201 may include a mobile-TV supporting device (e.g., a GPU). The mobile-TV supporting device, for example, may process media data according to standards (for example, digital multimedia broadcasting (DMB), digital video broadcasting (DVB), or mediaFlo™).

Each of the above-described component elements of hardware according to the present disclosure may be configured with one or more components, and the names of the corresponding component elements may vary based on the type of electronic device. In various embodiments, the electronic device may include at least one of the above-described elements. Some of the above-described elements may be omitted from the electronic device, or the electronic device may further include additional elements. Also, some of the hardware components according to various embodiments may be combined into one entity, which may perform functions identical to those of the relevant components before the combination.

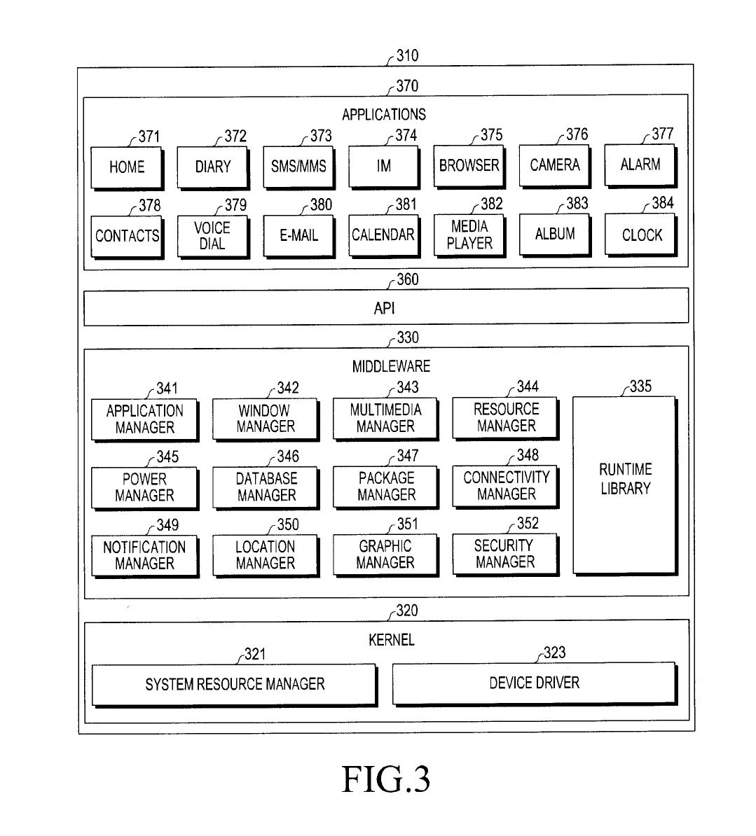

FIG. 3 is a block diagram of a program module, according to various embodiments of the present disclosure. According to an embodiment of the present disclosure, the program module 310 (e.g., the programs 140) may include an operating system for controlling resources that are related to the electronic device (e.g., the electronic device 101) and/or various applications (e.g., the application programs 147) that are executed under the operating system. The operating system, for example, may include Android, iOS, Windows, Symbian, Tizen, or Bada.

The program module 310 may include a kernel 320, middleware 330, an application programming interface (API) 360, and/or applications 370. At least some of the program module 310 may be pre-loaded in the electronic device for execution, or may be downloaded from external electronic devices (e.g., the electronic devices 102 and 104, or the server 106).

The kernel 320 (e.g., the kernel 141), for example, may include a system resource manager 321 and/or a device driver 323. The system resource manager 321 may perform control, allocation, or collection of the system resources. According to an embodiment, the system resource manager 321 may include a process management unit, a memory management unit, or a file system management unit. The device driver 323 may include, for example, a display driver, a camera driver, a Bluetooth driver, a common memory driver, a USB driver, a keypad driver, a Wi-Fi driver, an audio driver, or an inter-process communication (IPC) driver.

The middleware 330, for example, may provide functions that are required in common for the applications 370, or may provide the applications 370 with various functions through the API 360 in order to allow the applications 370 to effectively use limited system resources in the electronic device. According to an embodiment, the middleware 330 (e.g., the middleware 143) may include at least one of: a run time library 335; an application manager 341; a window manager 342; a multimedia manager 343; a resource manager 344; a power manager 345; a database manager 346; a package manager 347; a connectivity manager 348; a notification manager 349; a location manager 350; a graphic manager 351; or a security manager 352.

The run time library 335, for example, may include a library module that is used by a compiler in order to add new functions through programming languages while the applications 370 are executed. The run time library 335 may perform the management of an input/output, the management of a memory, or processing of an arithmetic function.

The application manager 341, for example, may manage a life cycle of at least one of the applications 370. The window manager 342 may manage a GUI resource that is used in the screen. The multimedia manager 343 may identify formats that are necessary for reproducing various media files, and may perform encoding or decoding of media files by using a codec corresponding to each format. The resource manager 344 may manage source codes of the one or more applications 370 or resources, such as the memory or a storage space.

The power manager 345, for example, may manage the battery or power by interworking with a basic input/output system (BIOS), and may provide power information necessary for the operation of the electronic device. The database manager 346, for example, may create, retrieve, or change a database that is to be used in the one or more applications 370. The package manager 347 may manage the installation or updating of the applications that are distributed in the form of a package file.

The connectivity manager 348, for example, may manage a wireless connection of Wi-Fi or Bluetooth. The notification manager 349 may provide the user with events, such as received messages, appointments, or proximity notifications without disturbing the user. The location manager 350, for example, may manage location information of the electronic device. The graphic manager 351, for example, may manage graphic effects to be provided to the user or user interfaces related thereto. The security manager 352, for example, may provide the overall security functions that are necessary for the system security or user verification. According to an embodiment, the middleware 330 may include a telephony manager for managing a function of voice call or a function of video call of the electronic device when the electronic device (e.g., the electronic device 101) adopts a phone-call function.

The middleware 330 may include a middleware module that forms a combination of the functions of the above-described elements. The middleware 330 may provide a module that is specialized according to the type of operating system for providing differentiated services. In addition, the middleware 330 may dynamically exclude some of the existing elements, or may add new elements.

The API 360 (e.g., the API 145), for example, may be a group of API programming functions, and may be provided with a different configuration according to an operating system. For example, one set of APIs may be provided to each platform in the case of Android or iOS, and two or more sets of APIs may be provided to each platform in the case of Tizen.

The applications 370 (e.g., the application programs 147) may include one or more applications that can execute a function of, for example, home 371, a dialer 372, SMS/MMS 373, instant messaging (IM) 374, a browser 375, a camera 376, an alarm 377, contact 378, voice dial 379, e-mail 380, a calendar 381, a media player 382, an album 383, a clock 384, healthcare (e.g., measuring the amount of exercise or blood glucose), or providing environmental information (e.g., providing atmospheric pressure, humidity, or temperature information).

According to an embodiment, the applications 370 may include an application (hereinafter, referred to as “information-exchange application”) that is able to support the exchange of information between the electronic device (e.g., the electronic device 101) and external electronic devices (e.g., the electronic devices 102 and 104). The information-exchange application, for example, may include a notification relay application for relaying specific information to the external electronic devices or a device management application for managing the external electronic devices.

For example, the notification relay application may transfer notification information that is generated in other applications (e.g., the SMS/MMS application, the e-mail application, the healthcare application, or the environmental information application) of the electronic device to external electronic devices (e.g., the electronic devices 102 and 104). In addition, the notification relay application, for example, may receive notification information from the external electronic devices to then provide the same to the user.

The device management application, for example, may manage (for example, install, delete, or update): one or more functions {e.g., turning on and off the external electronic device (or some elements) or adjusting the brightness (or resolution) of a display} of the external electronic device (e.g., the electronic device 102 or 104) that communicates with the electronic device; the applications that are executed in the external electronic device; or services (e.g., a phone-call service or a message service) that are provided by the external electronic device.

According to an embodiment of the present disclosure, the applications 370 may include applications (e.g., the healthcare application of a mobile medical device) that are designated according to the attribute of the external electronic device (e.g., the electronic device 102 or 104). According to an embodiment, the applications 370 may include applications that are received from the external electronic devices (e.g., the server 106 or the electronic devices 102 and 104). According to an embodiment of the present disclosure, the applications 370 may include preloaded applications or third party applications that can be downloaded from a server. The names of the components of the program module 310 according to the illustrated embodiment may vary according to the type of operating system.

According to various embodiments of the present disclosure, at least a part of the programming module 310 may be implemented in software, firmware, hardware, or a combination of two or more thereof. At least some of the program module 310 may be implemented (e.g., executed) by, for example, the processor (e.g., the processor 210). At least some of the program module 310 may include, for example, a module, a program, a routine, a set of instructions, and/or a process for performing one or more functions.

The term “module” as used herein may, for example, mean a unit including one of hardware, software and/or firmware in combination with hardware. The “module” may be interchangeably used with, for example, the term “unit”, “logic”, “logical block”, “component”, or “circuit”. The “module” may be a minimum unit of an integrated component element or a part thereof. The “module” may be a minimum unit for performing one or more functions or a part thereof. The “module” may be mechanically or electronically implemented. For example, the “module” according to the present disclosure may include at least one of an Application-Specific Integrated Circuit (ASIC) chip, a Field-Programmable Gate Arrays (FPGA), and a programmable-logic device for performing operations which has been known or are to be developed hereinafter.

According to various embodiments of the present disclosure, at least some of the devices (for example, modules or functions thereof) or the method (for example, operations) according to the present disclosure may be implemented by a command stored in a computer-readable storage medium in a programming module form. The instruction, when executed by a processor (e.g., the processor 120), may cause the one or more processors to execute a function corresponding to the instruction. The computer-readable storage medium may be, for example, the memory 130.

The computer readable recording medium may include a hard disk, a floppy disk, magnetic media (e.g., a magnetic tape), optical media (e.g., a Compact Disc Read Only Memory (CD-ROM) and a Digital Versatile Disc (DVD)), magneto-optical media (e.g., a floptical disk), a hardware device (e.g., a Read Only Memory (ROM), a Random Access Memory (RAM), a flash memory), and the like. In addition, the program instructions may include high class language codes, which can be executed in a computer by using an interpreter, as well as machine codes made by a compiler. The aforementioned hardware device may be configured to operate as one or more software modules in order to perform the operation of the present disclosure, and vice versa. The programming module according to the present disclosure may include one or more of the aforementioned components or may further include other additional components, or some of the aforementioned components may be omitted. Operations executed by a module, a programming module, or other component elements according to various embodiments of the present disclosure may be executed sequentially, in parallel, repeatedly, or in a heuristic manner. Further, some operations may be executed according to another order or may be omitted, or other operations may be added. Various embodiments disclosed herein are provided merely to easily describe technical details of the present disclosure and to help the understanding of the present disclosure, and do not limit the scope of the present disclosure. Therefore, it should be construed that all modifications and changes or modified and changed forms based on the technical idea of the present disclosure fall within the scope of the present disclosure.

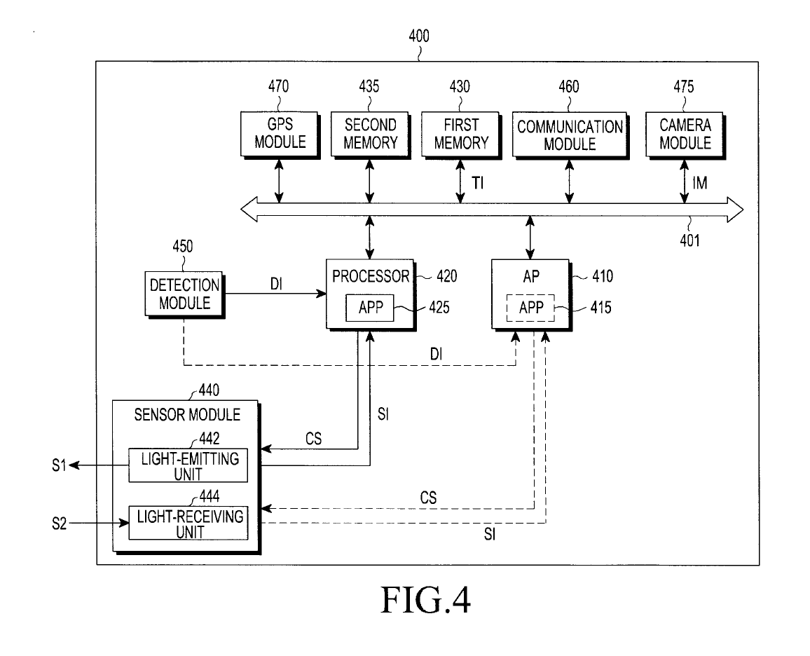

FIG. 4 is a schematic block diagram of an electronic device, according to an embodiment of the present disclosure.

Referring now to FIG. 4, the electronic device 400 may include a bus 401, an application processor 410, a processor 420, a first memory 430, a second memory 435, a sensor module 440, a detection module 450, a communication module 460, a GPS module 470, and a camera module 475. Each of the aforementioned modules includes hardware.

The electronic device 400 may be implemented to be substantially identical, or similar, to the electronic device 101, 102, or 104 shown in FIG. 1.

According to the embodiment of the present disclosure, the electronic device 400 may detect (sense) the occurrence of an event that is related to at least a part of the user's body (e.g., the user's skin), and may perform a function corresponding to the event by using information on at least a part of the user's body (e.g., the user's skin).

Hereinafter, for the convenience of explanation, the description will be made on the assumption that at least a part of the user's body being monitored is the user's skin. However, the technical concept of the present disclosure is not limited thereto, and may be applied to other parts of the user's body as well as the user's skin.

Elements 410, 420, 430, 435, 440, 450, 460, and/or 470 of the electronic device 400 may be connected to the bus 401, and may transmit and receive data through the bus 401.

The application processor 410 may control the overall operations of the electronic device. The application processor 410 may be implemented to be substantially identical, or similar, to the processor 120 of FIG. 1 or to the application processor 210 of FIG. 2.

According to this embodiment, the application processor 410 may detect an occurrence of an event that is related to the user's skin.

The application processor 410 may determine the skin color type of the user by using information (SI) on a light that is obtained from the sensor module 440. In addition, the application processor 410 may perform a function corresponding to the event by using the information (SI) on the light.

With continued reference to FIG. 4, the application processor 410 may receive an attachment/detachment signal (DI) from the detection module 450, and may perform a function corresponding to the attachment/detachment signal (DI).

In addition, the application processor 410 may include an application 415 under execution. For example, the application 415 may control the overall operations of the electronic device 400.

The processor 420 may control the overall operations of the electronic device. The processor 420 may be implemented to be substantially identical, or similar, to the processor 120 of FIG. 1 or to the application processor 210 of FIG. 2.

According to this embodiment, the processor 420 may detect the occurrence of an event that is related to the user's skin.

The processor 420 may determine the skin color type of the user by using information (SI) on a light that is obtained from the sensor module 440. In addition, the processor 420 may perform a function corresponding to the event by using the information (SI) on the light.

Meanwhile, the processor 420 may receive an attachment/detachment signal (DI) from the detection module 450, and may perform a function corresponding to the attachment/detachment signal (DI).

The attachment/detachment signal (DI) may refer to a signal that is generated by the detection module 450 when the electronic device 400 comes into contact with, or is detached from, a part of the user's body (e.g., the skin).

In addition, the processor 420 may control the operation of the sensor module 440. For example, the processor 420 may send, to the sensor module 440, a control signal (CS) for controlling the activation (or the activation degree) of the sensor module 440.

According to this embodiment, the processor 420 may be implemented by a low-power processor that can be operated by a low power. For example, the processor 420 may control the operation of the electronic device 400 in the low power state or in the low power mode. The low power state may refer to a state in which the power supply level of the electronic device 400 (or the power level of a power source) is less than a predetermined power level.

Although FIG. 4 shows the electronic device 400 having both the application processor 410 and the processor 420 for illustrative purposes, the various embodiments of the present disclosure are not limited to the depiction in FIG. 4, and the electronic device 400 may include at least one of the application processor 410 and the processor 420. In addition, the application processor 410 and the processor 420 may operate independently from each other.

The first memory 430 may store information or data that is related to the user's skin. According to the embodiment, the first memory 430 may be implemented by a non-volatile memory.

According to the embodiment, the first memory 430 may store type information (TI). In addition, to the processor 420 and/or the application processor 410 can retrieve from the first memory 430 the type information (TI).

The type information (TI) may contain information that is related to the skin. In addition, the type information (TI) may include information for performing a function corresponding to the event by using the information related to the skin.

For example, the type information (TI) may include: information on the light that is reflected by the skin, or that penetrates through the skin and then is reflected by blood vessels; information related to the skin corresponding to the information on the light; information on the output current intensity of a light-emitting unit of the sensor module 440; and/or information on the current intensity for the heart rate measurement corresponding to the information related to the skin. According to this embodiment, the information on the current intensity for the heart rate measurement may contain information on the current intensity of a light-emitting unit of the sensor module 440.

The first memory 430 may store the user's skin color type that is generated by the application processor 410 and/or the processor 420.

In addition, the first memory 430 may store applications 415 and/or 425 corresponding to events.

The second memory 435 may store data that is processed by the application processor 410 or the processor 420, and/or data that is processed by the applications 415 and/or 425. The second memory 435 may be implemented by a volatile memory (e.g., RAM).

The first memory 430 and the second memory 435 may be implemented to be substantially identical, or similar, to the memory 130 of FIG. 1, or the memory 230 of FIG. 2.

The sensor module 440 may obtain information (SI) on a light that is reflected (or generated) through the user's skin. According to this embodiment, the sensor module 440 may obtain information (SI) on a light that is reflected by the user's skin or on a light that penetrates through the skin and is then reflected by the blood vessels. Hereinafter, the information (SI) on the light that is reflected through (or by) the user's skin may refer to the information (SI) on the light that is reflected by the user's skin or on the light that penetrates through the skin and is then reflected by the blood vessels. The information (SI) on the light may refer to information on an optical signal that is output from the sensor module 440 and on an optical signal that is generated by being reflecting through the user's skin. In other words, since the ratio or intensity of the reflected optical signal may vary depending on the user's skin color or the skin color type, the information (SI) on the light may refer to information that is related to the ratio of the reflected optical signal or to the intensity of the reflected optical signal.

The sensor module 440 may include a light-emitting unit 442 and a light-receiving unit 444.

The light-emitting unit 442 may output a first optical signal (S1) to the user's skin. The light-emitting unit 442 may adjust the current intensity and/or voltage intensity of the first optical signal (S1) according to the control of the processor 420.

The light-emitting unit 442 may be implemented by a light-emitting element. For example, the light-emitting element may be implemented by an LED (Light-emitting Diode), an OLED (Organic Light-emitting Diode), an AMOLED (ActiveMatrix Organic Light-emitting Diode), an LD (Laser Diode), a solid laser, or other light-emitting elements.

According to this embodiment, the light-emitting unit 442 may include at least one of an IR (Infrared ray) LED, a Red LED, a Green LED, or a Blue LED. In addition, the light-emitting unit 442 may further include a UV (ultraviolet rays) light-emitting element.

Moreover, the first optical signal (S1) may include at least one of an infrared signal, a visible light signal, or a UV signal.

The light-receiving unit 444 may receive the second optical signal (S2) that is based on light passing through the user's skin and reflecting off blood vessels, or reflecting off the skin without passing through. S2 in an embodiment is essentially the reflection of the optical signal S1. At this time, the light “generated through the user's skin” may include the light is reflected back through the user's skin, and the light that is passed through the user's skin and is reflected through the body parts (e.g., the vessels).

According to the embodiment, the light-receiving unit 444 may be implemented by a photoelectric conversion element. For example, the photoelectric conversion element may be implemented by a photo diode or a pinned photo diode.

The light-receiving unit 444 may receive the second optical signal, and may transmit information (SI) on the light to the application processor 410 and/or the processor 420 in response to the second optical signal (S2).

The second optical signal (S2) refers to an optical signal that is generated by at least the first optical signal (S1) that is output from the light-emitting unit 442 and is reflected by the user's skin.

According to this embodiment, the second optical signal (S2) may include at least one of an infrared signal, a visible light signal, or a UV signal.

According to this embodiment, the sensor module may output the information about the light based on the first optical signal (S1) and the second optical signal (S2). In addition, the sensor module 440 may output the information (SI) about the light to the application processor 410 and/or the processor 420.

The sensor module 440 may receive a control signal (CS) from the processor 420, and may be activated in response to the control signal (CS). That is, the sensor module 440 may determine the activation degree in response to the control signal (CS).

The activation degree may refer to a state in which the sensor module 440 operates based on the operation state (or operation mode) of the electronic device 400.

According to this embodiment, the sensor module 440 may operate in at least one of a standby mode, a low power mode, or an activation mode depending on the activation degree.

The sensor module 440 may operate in the standby mode according to the control signal (CS) indicating the standby mode.

The standby mode may refer to a mode in which the sensor module 440 operates by a minimum driving power. In other words, the standby mode may refer to a state before the sensor module 440 enters the low power mode, or the activation mode. For example, the standby mode may refer to the initialization state of the sensor module 440.

The sensor module 440 may switch the state of the device from the standby mode into the low power mode, or the activation mode, in response to the control signal (CS). Alternatively, the sensor module 440 may continue to remain in the standby mode in response to the control signal (CS).

The sensor module 440 may operate in the activation mode according to the control signal (CS) indicating the activation mode.

The activation mode may refer to a mode in which the sensor module 440 activates sensors included therein and performs a sensing operation in order to execute a function corresponding to the event.

The sensor module 440 may operate in the low power mode in response to the control signal (CS) indicating the low power mode.

The low power mode may refer to a mode in which the sensor module 440 operates by a driving power that is less than that of the activation mode.

According to this embodiment, in the low power mode, the sensor module 440 may switch from the standby mode into the activation mode for a specific period of time and may perform the sensing operation in order to measure the user's skin color. The sensor module 440 may return to the standby mode after performing the sensing operation.

In other words, the low power mode may refer to a mode for activating the sensor module 440 for a specific period of time. In addition, in the low power mode, the sensor module 440 may be periodically activated.

If the sensor module 440 is activated only when an event occurs, the overall power consumption of the electronic device 400 may be reduced.

The detection module 450 may determine whether or not the electronic device 400 is in contact with the user's skin.

According to this embodiment, the detection module 450 may identify whether or not the electronic device 400 has contact with the user's skin, and if it is identified that the electronic device 400 has been in contact with the user's skin, the detection module 450 may transmit a contact signal (DI) to the application processor 410 and/or the processor 420.

Although the detection module 450 and the sensor module 440 are illustrated to be separated in FIG. 4, according to an embodiment, the detection module 450 may be included in the sensor module 440.

The communication module 460 includes hardware to transmit and receive data to and from other electronic devices, and/or a server by using wireless communication technology.

According to this embodiment, the communication module 460 may receive data on the user's skin from other electronic devices and may transmit data on the user's skin to the other electronic devices by using wireless communication technology. The wireless communication technology may be implemented to be substantially identical to the wireless communication described in FIG. 1.

The GPS module 470 may receive GPS signals. In response to the GPS signals, the GPS module 470 may transmit location information corresponding to the GPS signals to the application processor 410 and/or the processor 420.

The camera module 475 may photograph images, and may transmit the photographed images to the application processor 410 and/or the processor 420.

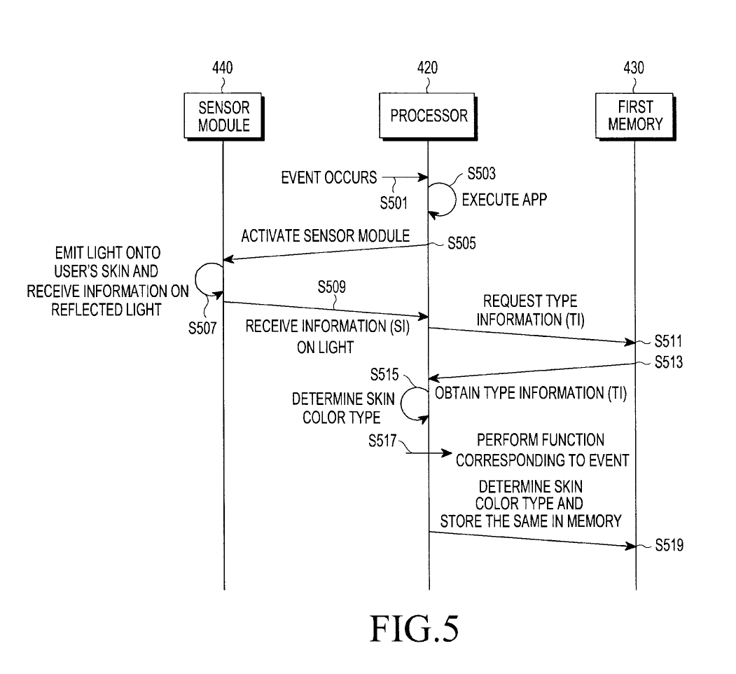

FIG. 5 is a data flow illustrating a control method of the electronic device shown in FIG. 4.

Referring now to FIGS. 4 and 5, the processor 420 may control the overall operations of the electronic device 400.

Although the processor 420 is illustrated to control the electronic device 400 in FIG. 5, the embodiments of the present disclosure are not limited thereto, and the application processor 410, for example, may be used to control the electronic device 400.

At (S501), the processor 420 may detect the occurrence of an event that is related to the user's skin. At this time, the event (or the occurrence of the event) related to the user's skin may refer to the operation of a program, the operation of an application, and/or the operation of an electronic device, in relation to the user's skin. In other words, the occurrence of the event may mean the operation of a program, the operation of an application, and/or the operation of an electronic device, which require information related to the user's skin.

At (S503), if the occurrence of the event is detected, the processor 420 may execute the application 425. In addition, the processor 420 may control a specific operation of the electronic device 400 in response to the occurrence of the event.

The application 425 may be an application corresponding to the occurrence of the event. According to the embodiment, the application 425 may be implemented as an application for performing a function that is related to the user's skin. For example, the application 425 may comprise a heart rate measurement application, a camera application, a UV exposure allowance time management application, a UV exposure guidance application, a vitamin D synthesis management application, a skin moisture measurement application, a skin health guidance application, an image correction application, or a health status checking application, which is related to the user's skin.

The application executed in response to the occurrence of the event may be configured by a user or a program.

In addition, the following description will be made on the assumption that the control of the operation of the electronic device 400 by the application 425 refers the control of the operation of the electronic device 400 by the processor 420.

According to this embodiment, the specific operation may be an operation in which the processor 420 controls the activation degree of the sensor module 440. In other words, the processor 420 may detect the occurrence of an event, and may then determine the activation degree of the sensor module 440 with respect to the detected event. For example, the processor 420 may send, to the sensor module 440, a control signal for controlling the activation degree of the sensor module 440 on the basis of the event.

At (S505), the processor 420 may activate the sensor module 440 according to the detection result. For example, the processor 420 may transmit a signal for requesting information (SI) on the reflected light to the sensor module 440. Meanwhile, the signal for requesting the information (SI) on the light may be implemented by a control signal (CS).

At (S507), the sensor module 440 may output an optical signal to the user's skin, and may obtain the information (SI) on the light on the basis of the reflected optical signal.

At (S509), the sensor module 440 may transmit the information (SI) on the light to the processor 420.

At (S511), the processor 420 may receive the information (SI) on the light, and may make a request to the first memory 430 for type information (TI).

At (S513), the processor 420 may read the type information (TI) from the first memory 430. Hereinafter, for the convenience of explanation, the memory 430 is defined to mean the first memory 430.

At (S515), the processor 420 may compare the type information (TI) with the information (SI) on the light, and may determine the skin color type corresponding to the information (SI) on the light.

In addition, at (S517) the processor 420 may control the performance of a function corresponding to the event by using information corresponding to the information (SI) on the light among the type information (TI).

At (S519), the processor 420 may determine the skin color type, and may store information on the user's skin color type in the memory 430.

The skin color type may refer to information showing a person's skin color, which is classified according to a specific criterion. For example, the user's skin color type may be determined by using the Fitzpatrick Scale and/or ITA (individual typology angle) values.

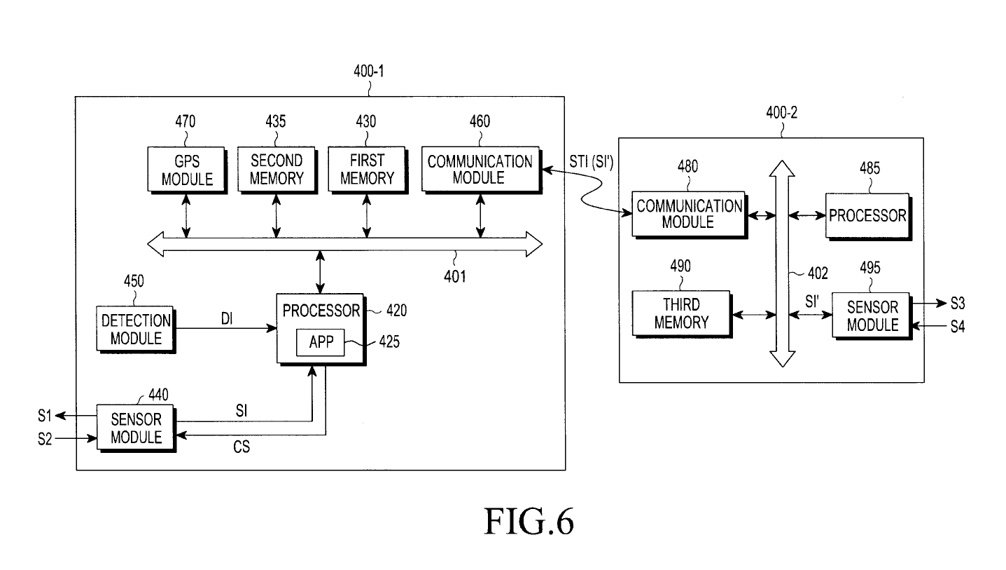

FIG. 6 is a schematic block diagram of an electronic device, according to another embodiment of the present disclosure.

Referring now to FIG. 6, the electronic system may include the first electronic device 400-1 and the second electronic device 400-2.

The first electronic device 400-1 may be implemented to be substantially identical, or similar, to the electronic device 400 such as described in FIG. 4.

The first electronic device 400-1 may transmit and receive data to and from the second electronic device 400-2by using the first communication module 460. For example, the first electronic device 400-1 may be implemented by a wearable electronic device or a mobile computing device.

The sensor module 440 included in the first electronic device 400-1 may form a functional connection through a communication connection with the second electronic device 400-2.

The first electronic device 400-1 may detect the occurrence of an event related to the skin, and may transmit a control signal for activating the sensor module 440 to the second electronic device 400-2.

The second electronic device 400-2 may include the second communication module 480, a processor 485, the third memory 490, and a sensor module 495. The elements 480, 485, 490, and 495 of the second electronic device 400-2 may be connected by a bus 402, and may transmit data via the bus 402.

The second electronic device 400-2 may transmit the skin color type information (skin color type index, STI) of the user to the first electronic device 400-1, and may receive the skin color type information (STI) of the user from the first electronic device 400-1. For example, the second electronic device 400-2 may be implemented by a smart phone, a server, a PC (Personal Computer), a laptop computer, a notebook computer, or other computing devices.

In addition, the second electronic device 400-2 may transmit information (SI′) on a light that is reflected through the user's skin to the first electronic device 400-1.

The second communication module 480 may transmit and receive the skin color type information (STI) to and from the first communication module 460.

The processor 485 may control the overall operations of the second electronic device 400-2.

The third memory 490 may store the skin color type information (STI) that is transmitted from the second communication module 480. In addition, the third memory 490 may transmit the stored skin color type information (STI) to the communication module 480 under the control of the processor 485. Meanwhile, the third memory 490 may store the type information (TI).

The sensor module 495 may obtain the information (SI′) on the light that is reflected through the user's skin.

The information (SI′) on the reflected light is substantially identical to the information (SI) on the light, which has been described in FIG. 4. In other words, the information (SI′) on the reflected light may mean an optical signal (S3) that is output from the sensor module 495 and the information on the optical signal (S4) that is generated by being reflected through the user's skin.

The sensor module 495 may be implemented to be substantially identical to the sensor module 440 included in the first electronic device.

According to this embodiment, the sensor module 495 may generate the information (SI′) on the reflected light based on the output optical signal (S3) and the reflected and generated optical signal (S4).

The sensor module 495 may transmit the information (SI′) on the reflected light to the processor 485 and/or the communication module 480.

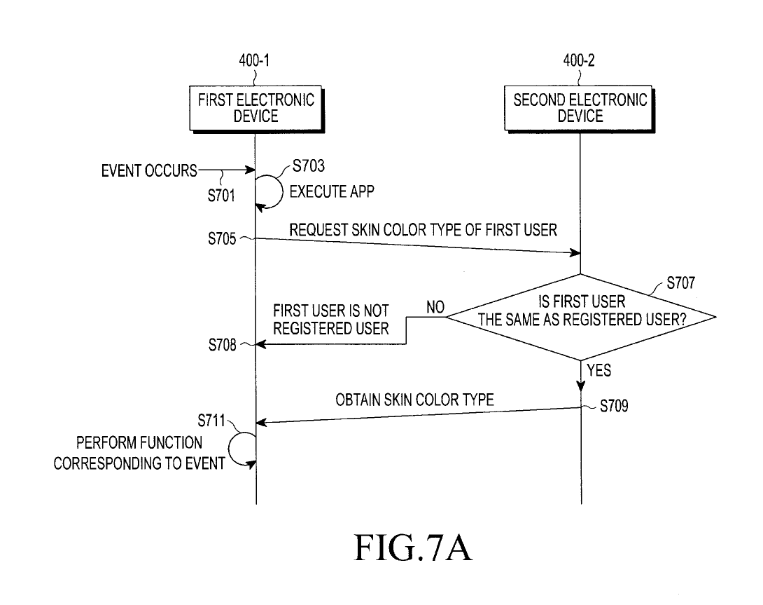

FIGS. 7A to 7D are data flows illustrating various embodiments of a control method of the electronic device shown in FIG. 6.

Referring to FIG. 6 and FIGS. 7A to 7D, the processor 420 may control the overall operations of the first electronic device 400-1.

FIG. 7A is a data flow illustrating an embodiment of a control method of the electronic device shown in FIG. 6.

At (S701), the processor 420 may detect the occurrence of an event that is related to the user's skin.

At (S703), when the occurrence of the event is detected, the processor 420 may execute the application 425.

According to the detection result, at (S705) the processor 420 may make a request to the second electronic device 400-2 for the skin color type information (STI) of the first user. At this time, the first user refers to a user who is registered in the first electronic device and/or the second electronic device. The first user may be pre-configured or registered by the user.

At (S705), for example, the processor 420 may transmit a request signal for the skin color type information (STI) of the first user through the communication module 460. The request signal may contain an ID indicating the first user.

At (S707), the second electronic device 400-2 may determine whether or not the first user is the same as a registered user in response to the request signal.

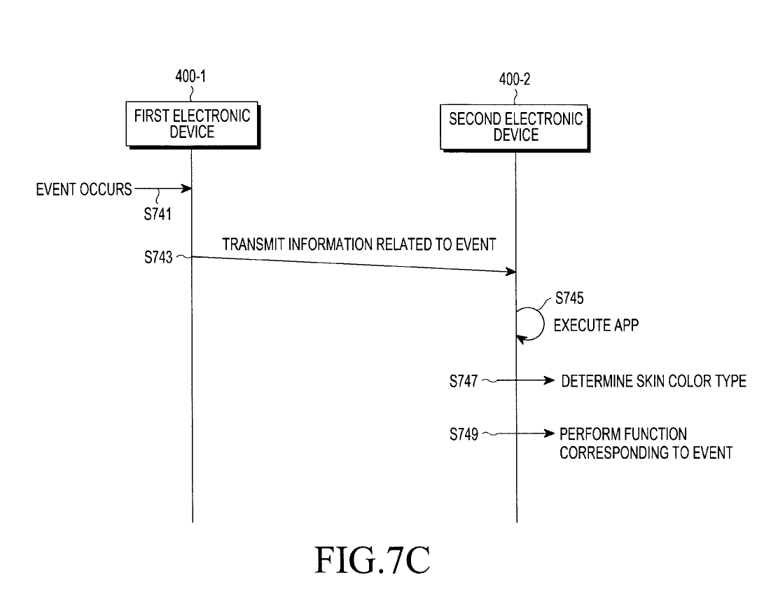

FIG. 9 is a table representing skin color type information that is stored in the second electronic device shown in FIG. 6.

Referring now to FIG. 9, the second electronic device 400-2 may compare an ID of the first user with an ID (ID1) of the registered first user, and may obtain the skin color type information (STI) according to the comparison result.

If the first user is the same as the first registered user, the second electronic device 400-2 may transmit the skin color type information (for example, black) of the first user to the first electronic device 400-1 (S709).

Meanwhile, at (S708), if the first user is not the same as the first registered user, the second electronic device 400-2 may transmit, to the first electronic device 400-1, a signal stating that the first user is not a registered user (S708).

At (S709), the first electronic device 400-1 may obtain the skin color type information (STI) from the second electronic device 400-2.

At (S711), the processor 420 may perform a function corresponding to the event by using the skin color type information (STI) of the first user.

FIG. 7B is a data flow illustrating another embodiment of the control method of the electronic device shown in FIG. 6.

At (S721), the processor 420 may detect the occurrence of an event that is related to the user's skin.

At (S723), when the occurrence of the event is detected, the processor 420 may execute the application 425.

According to the detection result, at (S725), the processor 420 may make a request to the second electronic device 400-2 for the skin color type information (STI) of the user.

For example, at (S725), the processor 420 may transmit a request signal for the skin color type information (STI) of the user through the communication module 460.

At (S727), the second electronic device 400-2 may determine the skin color type of the user in response to the request signal. According to the embodiment, the second electronic device 400-2 may determine the skin color type of the user by using the sensor module 495. At this time, the method in which the second electronic device 400-2 determines the skin color type of the user may be implemented to be substantially identical, or similar, to the method in which the first electronic device determines the skin color type of the user in FIG. 5.

At (S729), the second electronic device 400-2 may transmit, to the first electronic device 400-1, the skin color type information (STI) that has been determined through the second communication module 480.

At (S731), the first electronic device 400-1 may perform a function corresponding to the event by using the skin color type information (STI).

FIG. 7C is a data flow illustrating still another embodiment of the control method of the electronic device shown in FIG. 6.

At (S741), the processor 420 may detect the occurrence of an event that is related to the user's skin.

When the occurrence of the event is detected, at (S743), the processor 420 may transmit information related to the event to the second electronic device 400-2 through the first communication module 460. At this time, the information related to the event may contain information by which the second electronic device 400-2 may perform a function corresponding to the event.

At (S745), when the second electronic device 400-2 receives the information related to the event, the second electronic device 400-2 may execute an application related to the event.

At (S747), the second electronic device 400-2 may determine the skin color type of the user. At this time, the method in which the second electronic device 400-2 determines the skin color type of the user may be implemented to be substantially identical, or similar, to the method in which the first electronic device determines the skin color type of the user in FIG. 5.

At (S749), the second electronic device 400-1 may perform a function corresponding to the event by using the determined skin color type.

FIG. 7D is a data flow illustrating yet another embodiment of the control method of the electronic device shown in FIG. 6.

At (S761), the processor 420 may detect the occurrence of an event that is related to the user's skin.

At (S763), when the occurrence of the event is detected, the processor 420 may execute the application 425.

According to the detection result, at (S765), the processor 420 may make a request to the second electronic device 400-2 for information (SI′) on the light that is reflected through the user's skin.

For example, at (S765), the processor 420 may transmit a request signal for the information (SI′) on the light, which is reflected through the user's skin, through the communication module 460.

At (S767), the second electronic device 400-2 may obtain the information (SI′) on the light, which is reflected through the user's skin, in response to the request signal.

According to the embodiment, the second electronic device 400-2 may obtain the information (SI′) on the reflected light by using the sensor module 495. At this time, the method in which the second electronic device 400-2 obtains the information (SI′) on the reflected light may be implemented to be substantially identical, or similar, to the method in which the first electronic device obtains the information (SI) on the light, which has been described in FIG. 5.

AT (S769), the second electronic device 400-2 may transmit, to the first electronic device 400-1, the information (SI′) on the reflected light through the second communication module 480.

At (S771), the first electronic device 400-1 may determine the skin color type of the user based on the information (SI′) on the reflected light in order to generate skin color type information (STI).

At (S773), the first electronic device 400-1 may perform a function corresponding to the event by using the skin color type information (STI).

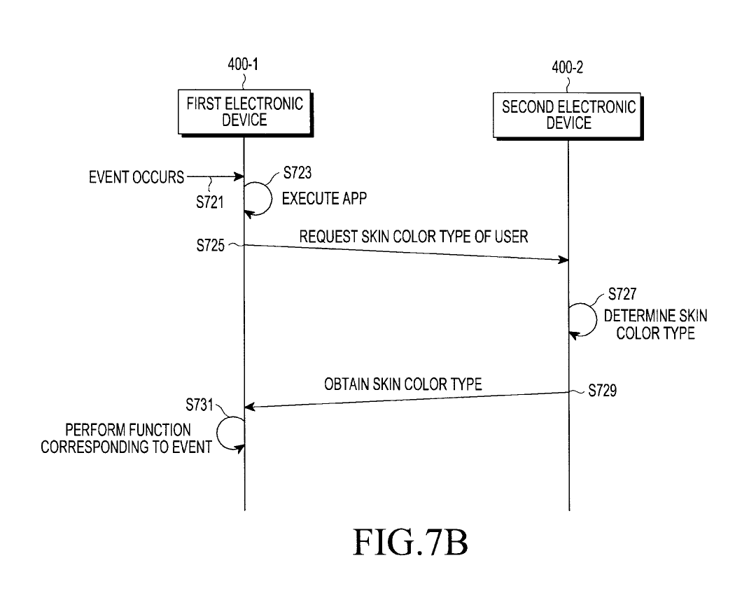

FIG. 8 is a data flow illustrating a control method of the electronic device shown in FIGS. 4 and 6.

Referring now to FIGS. 4, 6, and 8, the processor 420 may control the overall operations of the first electronic device 400.

At (S801), the processor 420 may detect the occurrence of an event that is related to the user's skin

At (S803), when the occurrence of the event is detected, the processor 420 may execute the application 425.

According to the detection result, at (S805) the processor 420 may make a request to the camera module 475 for image information (IM).

The image information (IM) may refer to image data or video image data that is photographed by the camera module 475. In addition, the image information (IM) may contain information that is related to the user's skin.

Alternatively, the processor 420 may make a request to the memory 430 for the image information (IM). At this time, the image information (IM) may mean data that is photographed by the camera module 475 and is stored in the memory 430.

At (S807), the camera module 475 may photograph images, and at (S809) may transmit the photographed image information (IM) to the processor 420.

At (S811). the processor 420 may analyze the image information (IM) obtained from the camera module 475. At (S813), the processor 420 may determine the skin color type of the user by using the analysis result.

For example, the processor 420 may: analyze the image information (IM); obtain color temperature information from the analyzed image information; and determine the skin color type of the user by using the obtained color temperature information.

The processor 420 may perform a function corresponding to the event by using the determined skin color type (S813).

FIG. 10 is a flowchart illustrating a control method of the electronic device, according to various embodiments of the present disclosure.

Referring now to FIGS. 4 to 10, at (S1001) the electronic device 400 or 400-1 may detect the occurrence of an event that is related to the user's skin according to the control of the processor and/or the application processor. Hereinafter, although the processor 420 controls the operation of the electronic device 400 or 400-1 for the convenience of description, the operation of the electronic device 400 or 400-1 may be controlled by the application processor 410 and/or the processor 420.

At (S1003), the processor 420 may determine the skin color type information (STI) of the user in response to the occurrence of the event related to the user's skin. According to the embodiment, the skin color type information (STI) may be determined by the information (SI) on the light reflected by the user's skin, which is obtained from the sensor module 440, and the type information (TI) that is stored in the memory.

At (S1005) The processor 420 may control the electronic device 400 or 400-1 to perform a function corresponding to the event.

Meanwhile, in response to the occurrence of the event related to the user's skin, the processor 420 may perform a function corresponding to the event by using the information (SI) on the light reflected by the user's skin and the type information (TI) stored in the memory.

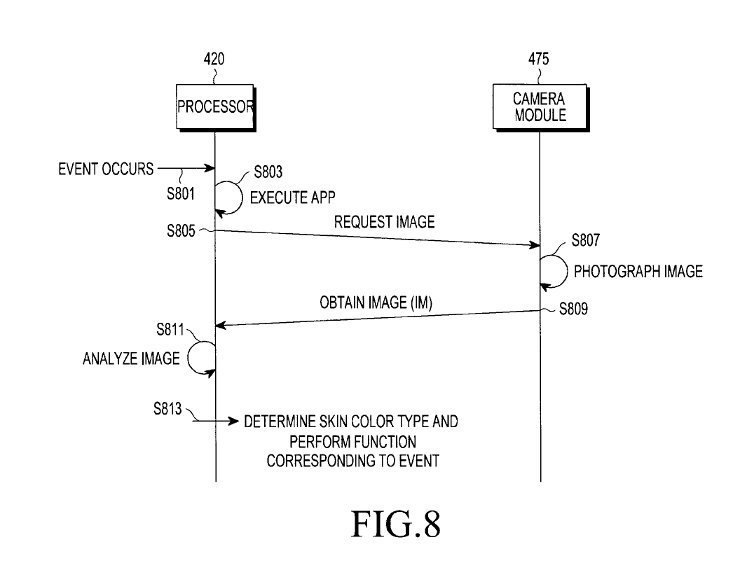

FIG. 11 is a flowchart illustrating a control method of the electronic device, according to various embodiments of the present disclosure.

Referring now to FIGS. 4, 10, and 11, at (S1101) the processor 420 may detect the occurrence of an event that is related to the user's skin.

The processor 420 may activate the sensor module 440 in response to the occurrence of the event. For example, when an attachment/detachment event occurs, or a heart rate measurement application is executed, the processor 420 may activate the sensor module 440.

The attachment/detachment event may refer to an operation (or a state) in which the electronic device 400 or 400-1 comes into contact with, or is detached from, the user's skin.

At this time, the occurrence of the attachment/detachment event and the execution of the heart rate measurement application are only examples of the events, and the technical concept of the present disclosure is not limited thereto.

At (S1103), the light-emitting unit 442 included in the sensor module 440 may output the first optical signal (S1) to the user's skin. At this time, the first optical signal (S1) may include at least one of an infrared signal, an ultraviolet signal, a red signal, a green signal, or a blue signal. According to the embodiment, the first optical signal (S1) may include an infrared signal and a red signal.

At (S1105), the light-receiving unit 444 may receive the second optical signal (S2) that is generated by an operation in which the first optical signal (S1) is reflected through the user's skin, and may transmit information (SI) on the light to the processor 420.

At (S1107), the processor 420 may receive the information (SI) on the reflected light, and may convert the information (SI) on the light into a melanin index (MI).

According to this embodiment, the processor 420 may convert the information (SI) on the light into the melanin index (MI) by using Equation 1:

MI=500/(log 5(log IR−log R)+500) [Equation 1]

At this time, “IR” refers to a value (or a ratio value) of an infrared signal that is received by the light-receiving unit, which is determined based on an infrared signal that is output from the light-emitting unit 442 and an infrared signal that is reflected (or generated) through the user's skin.

“R” refers to a value (or a ratio value) of a red signal that is received by the light-receiving unit, which is determined based on a red signal that is output from the light-emitting unit 442 and a red signal that is reflected (or generated) through the user's skin.

At this time, the intensity (or a value) of the infrared signal and the intensity (or a value) of the red signal, which are output from the light-emitting unit 442, may be configured by the user or by a program.

The processor 420 may compare the converted melanin index (MI) with the type information (TI) stored in the memory 430.

At (S1109), the processor 420 may determine the skin color type information (STI) corresponding to the converted melanin index (MI) among the type information (TI) according to the comparison result.

At (S1111), the processor 420 may perform a function corresponding to the event on the basis of the skin color type information (STI). For example, if the event relates to the heart rate measurement, the processor 420 may configure the current intensity for the heart rate measurement based on the skin color type information (STI).

Meanwhile, the processor 420, instead of determining the skin color type, may compare the converted melanin index (MI) and the type information (TI) stored in the memory 430, and may perform a function corresponding to the converted melanin index (MI) among the type information (TI) according to the comparison result.

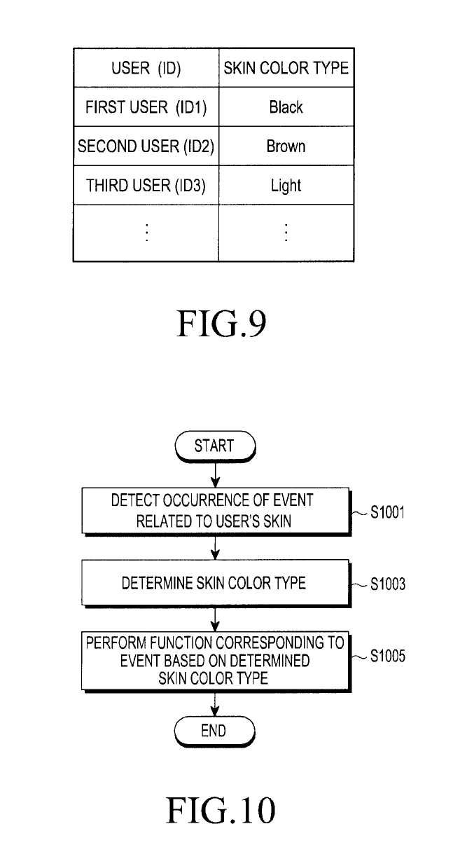

FIG. 12 is an example of a table showing type information related to the melanin index described in FIG. 11.

Referring now to FIGS. 4, 11, and 12, the type information (TI) may contain type information (TI1) that is related to the melanin index.

Although the type information (TI1) of FIG. 12 shows a table for the melanin indexes (MI) and the current intensities for the heart rate measurement for the convenience of explanation, the technical concept of the present disclosure is not limited thereto.

According to the embodiment, if the heart rate measurement application is executed, the processor 420 may convert the information (SI) on the reflected light into a melanin index.

The processor 420 may compare the information (SI) on the reflected light with the type information (TI1) related to the melanin index. According to the comparison result, the processor 420 may determine the skin color type information (STI) of the user, and may determine the current intensity of the light-emitting unit 442 of the sensor module 440 for measuring the heart rate.

For example, if the converted melanin index is 15, the processor 420 may determine the skin color type of the user to be “Light”, and may determine the current intensity of the light-emitting unit 442 to be a value corresponding to 41% to 50% of a maximum input value. In addition, if the converted melanin index is 50, the processor 420 may determine the skin color type of the user to be “Brown”, and may determine the current intensity of the light-emitting unit 442 to be a value corresponding to 71% to 80% of a maximum input value.

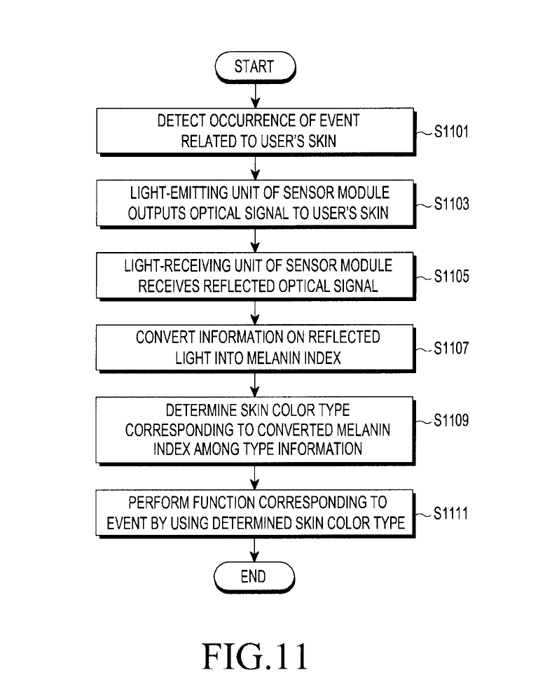

FIG. 13 is a flowchart illustrating a control method of the electronic device, according to various embodiments of the present disclosure.

Referring now to FIGS. 4 and 13, At (S1301), the processor 420 may detect the occurrence of an event that is related to the user's skin.

The processor 420 may activate the sensor module 440 in response to the event (or the occurrence of the event). For example, when a heart rate application is executed, the processor 420 may activate the sensor module 440.

(At S1303), the light-emitting unit 442 included in the sensor module 440 may output the first optical signal (S1) to the user's skin. At this time, the first optical signal (S1) may include at least one of an infrared signal, a UV signal, a red signal, a green signal, or a blue signal. According to the embodiment, the first optical signal (S1) may include a red signal, a green signal, and a blue signal.

At (S1305), the light-receiving unit 444 may receive the second optical signal (S2) that is generated by the operation in which the first optical signal (S1) is reflected through the user's skin, and may transmit information (SI) on the light to the processor 420.

At (S1307), the processor 420 may receive the information (SI) on the reflected light, and may convert the information (SI) on the light into a color space value. For example, the processor 420 may convert the information (SI) on the light, which is implemented with RGB values, into a color space value.

At this time, the color space value may be implemented to be a CIE (Commission International de I'eclairage) L*a*b* color space value, a CIE XYZ color space value, a YIQ color space value, and/or a YUV color space value. According to the embodiment, the color space value may be implemented by the CIE L*a*b*.

The processor 420 may convert the converted color space value into an ITA value (S1307).

The ITA value (individual typology angle value, ITAV) may refer to an ITA value that is classified in “Colorimetric determination of skin color typing and prediction of minimal erythemal dose (MED) without UV exposure” which is a guideline of Colipa, the European Cosmetics Association.

According to the embodiment, the processor 420 may convert the color space value into the ITA value (ITAV) by using Equation 2.

ITAV=(Arc Tan(L*−50)/b*)×180/3.14159 [Equation 2]

Here, L*may refer to L* of the color space value (e.g., CIE L*a*b*), and L* may mean the brightness. b* may refer to b* of the color space value (e.g., CIE L*a*b*), and b* may mean values for the yellow and blue.

At this time, “L*” refers to the brightness of an RGB signal value (or ratio value) received by the light-receiving unit, which is determined based on an RGB signal that is output from the light-emitting unit 442 and an RGB signal that is reflected (or generated) through the user's skin.

In addition, “b*” refers to a value for the yellow and blue of an RGB signal value (or ratio value) received by the light-receiving unit, which is determined based on an RGB signal that is output from the light-emitting unit 442 and an RGB signal that is reflected (or generated) through the user's skin.

At this time, the intensity (or a value) of the RGB signal output from the light-emitting unit 442 may be configured by the user or by a program.

At (S1309), the processor 420 may compare the converted ITA value (ITAV) with the type information (TI) stored in the memory 430. According to the comparison result, the processor 420 may determine the skin color type information (STI) corresponding to the converted value ITA (ITAV) among the type information (TI).

At (S1311), the processor 420 may perform a function corresponding to the event based on the determined skin color type information (STI). For example, the processor 420 may configure the current intensity for measuring the heart rate on the basis of the skin color type information (STI).

Meanwhile, the processor 420, instead of determining the skin color type, may compare the converted ITA value with the type information (TI) stored in the memory 430, and may perform a function corresponding to the converted ITA value among the type information (TI) according to the comparison result.

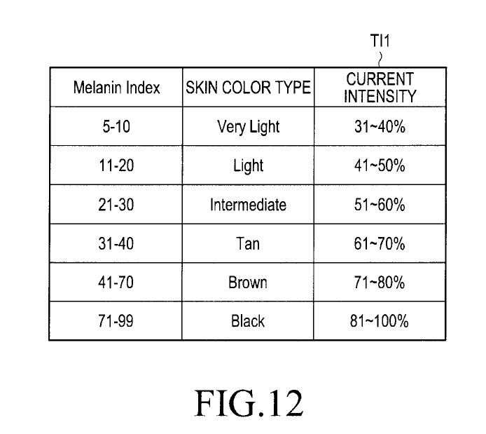

FIG. 14 is an example of a table showing the type information related to the color space conversion described in FIG. 13.

Referring now to FIGS. 4, 5, 13, and 14, the type information (TI) may contain the type information (TI2) that is related to the ITA value.

Although the type information (TI2) of FIG. 14 shows a table for the ITA values and the current intensities for measuring the heart rate for the convenience of explanation, the technical concept of the present disclosure is not limited thereto.

According to the embodiment, if the heart rate measurement application is executed, the processor 420 may convert the information (SI) on the reflected light into an ITA value.

The processor 420 may compare the information (SI) on the reflected light with the type information (TI2). According to the comparison result, the processor 420 may determine the skin color type information (STI) of the user, and may determine the current intensity of the light-emitting unit 442 of the sensor module 440 for measuring the heart rate.

For example, if the converted ITA value is 45 degrees, the processor 420 may determine the skin color type of the user to be “Light”, and may determine the current intensity of the light-emitting unit 442 to be a value corresponding to 41% to 50% of a maximum input value. In addition, if the converted ITA value is 0 degree, the processor 420 may determine the skin color type of the user to be “Brown”, and may determine the current intensity of the light-emitting unit 442 to be a value corresponding to 71% to 80% of a maximum input value.

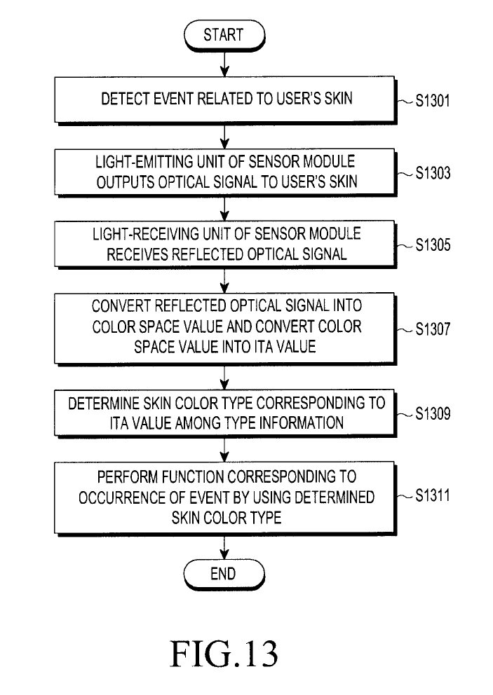

FIG. 15 is a flowchart illustrating a control method of the electronic device, according to various embodiments of the present disclosure.

Referring now to FIGS. 4, 5, and 15, at (S1501), the processor 420 may detect the occurrence of an event that is related to the user's skin. According to the embodiment, the occurrence of the event may be the execution of a camera application.

The camera application may refer to: an application that is related to photographing of the camera; an application that is related to images photographed by the camera; and/or an application related to the camera.

When the camera application is executed, the processor 420 may activate the sensor module 440. At this time, At (S1503), the processor 420 may receive information (SI) on the light from the sensor module 440, and may determine the skin color type of the user by using the information (SI) on the light and the type information (TI) stored in the memory 430.

At this time, the method for determining the skin color type (S1503) may utilize the method described in FIGS. 11 to 14. In other words, the skin color type information (STI) of the user may be determined by using the information (SI) on the light, which is obtained from the sensor module 440.

Meanwhile, the method for determining the skin color type (S1503) may include operations of: obtaining information on the skin color type from other modules (e.g., the camera module 475) included in the other electronic device 400-2 and/or the electronic device 400 or 400-1; and determining the skin color type information (STI) of the user by using the obtained information on the skin color type.

At (S1505), the processor 420 may generate camera exposure correction information based on the determined skin color type (S1505).

The camera exposure correction information means information for correcting the exposure degree with respect to light when photographing by the camera.

The processor 420 may transmit the camera exposure correction information to the camera module 475, and may control the camera module 475 by using the camera exposure correction information.

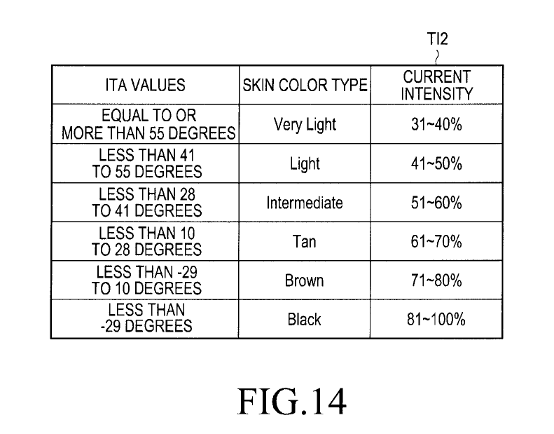

FIG. 16 is a flowchart illustrating a control method of the electronic device, according to various embodiments of the present disclosure.

Referring now to FIGS. 4, 6, 15, and 16, (at (S1601), the processor 420 may detect the occurrence of an event that is related to the user's skin. According to the embodiment, the occurrence of the event may be the execution of a camera application.

The camera application may mean; an application that is related to the photographing of the camera; an application that is related to images photographed by the camera; and/or an application related to the camera.

When the camera application is executed, the processor 420 may activate the sensor module 440. At this time, at (S1603), the processor 420 may receive information (SI) on the light from the sensor module 440, and may determine the skin color type of the user by using the information (SI) on the light and the type information (TI) stored in the memory 430.

At this time, the method for determining the skin color type (S1603) may utilize the method described in FIGS. 13 to 14. In other words, the skin color type information (STI) of the user may be determined by using the information (SI) on the light, which is obtained from the sensor module 440.

Meanwhile, the method for determining the skin color type (S1603) may include operations of: obtaining information on the skin color type from other modules (e.g., the camera module 475) included in the other electronic device 400-2 and/or the electronic device 400 or 400-1; and determining the skin color type information (STI) of the user by using the obtained information on the skin color type.

At (S1605), the processor 420 may generate image correction information based on the determined skin color type.

The image correction information refers to information for correcting images photographed by the camera. For example, the image correction information means information that is capable of correcting the skin color of the user contained in the image photographed by the camera.

The processor 420 may transmit the image correction information to the camera module 475, and may control the camera module 475 by using the image correction information.

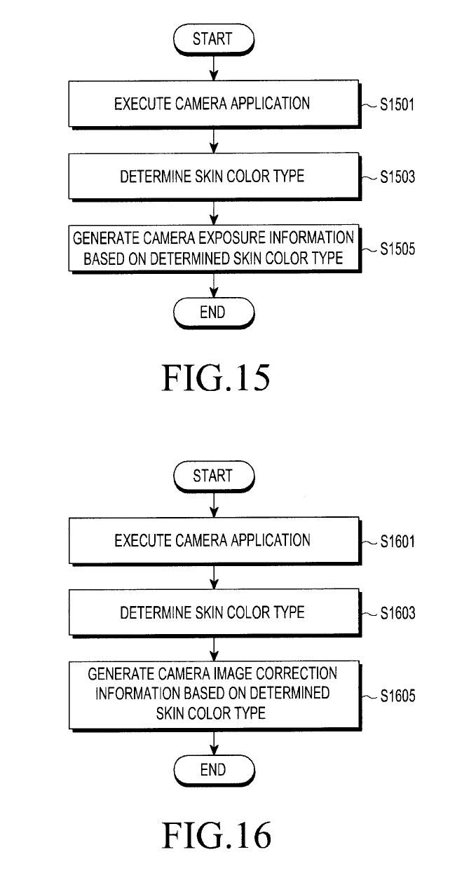

FIG. 17 is a flowchart illustrating a control method of the electronic device, according to various embodiments of the present disclosure.

Referring now to FIGS. 4, 6, and 17, at (S1701), the processor 420 may detect the occurrence of an event that is related to the user's skin. According to this embodiment, the event (or the occurrence of the event) may be the occurrence of updating weather information and/or season information.

The update of weather information and/or season information may mean the update of weather information and/or season information, the update of applications that are related to weather information and/or season information, or a change in the ambient temperature or humidity.

If the update of weather information and/or season information occurs, the processor 420 may activate the sensor module 440.

At this time, at (S1703), the processor 420 may receive information (SI) on the light from the sensor module 440, and may determine the skin color type information (STI) of the user by using the information (SI) on the light and the type information (TI) stored in the memory 430.

At this time, the method for determining the skin color type (S1703) may utilize the method described in FIGS. 11 to 14. That is, the skin color type information (STI) of the user may be determined by using the information (SI) on the light, which is obtained from the sensor module 440.

Meanwhile, the method for determining the skin color type (S1703) may include operations of: obtaining information on the skin color type from other modules (e.g., the camera module 475) included in the other electronic device 400-2 and/or the electronic device 400 or 400-1; and determining the skin color type information (STI) of the user by using the obtained information on the skin color type.

At (S1705), the processor 420 may determine a UV exposure allowance time based on the determined skin color type information (STI). At this time, the processor 420 may determine (or calculate) the UV exposure allowance time based on the skin color type information (STI) of the user, or may determine the UV exposure allowance time by using data for the UV exposure allowance time, which is stored in the memory 430.

The UV exposure allowance time may mean a maximum UV exposure allowance time according to the skin color type of the user. In addition, the UV exposure allowance time may also mean an appropriate UV exposure allowance time according to the skin color type of the user.

At (S1707), the processor 420 may provide UV exposure-related information to the user. The UV exposure-related information may be generated by using the UV exposure allowance time. In other words, the UV exposure-related information may mean UV exposure guidance information depending on the user's skin.

According to the embodiment, the processor 420 may transmit the UV exposure-related information to an application related to the UV exposure, an application related to health information, and an application related to biometric information.

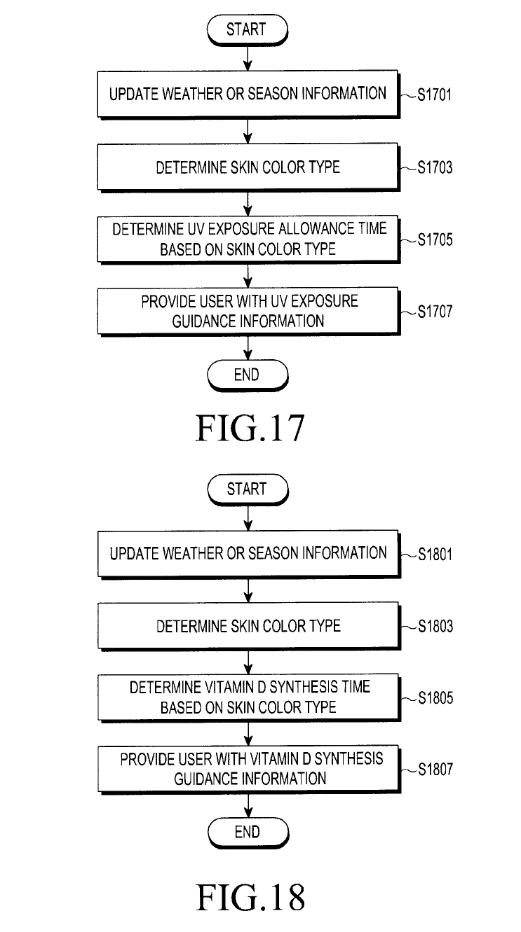

FIG. 18 is a flowchart illustrating a control method of the electronic device, according to various embodiments of the present disclosure.

Referring now to FIGS. 4, 6, 17, and 18, at (S1801) the processor 420 may detect the occurrence of an event that is related to the user's skin. According to the embodiment, the occurrence of the event may be the occurrence of updating weather information and/or season information (S1801).

The update of weather information and/or season information may mean the update of weather information and/or season information, the update of applications related to weather information and/or season information, or a change in the ambient temperature or humidity.

If the update of weather information and/or season information occurs, the processor 420 may activate the sensor module 440.

At this time, at (S1803), the processor 420 may receive information (SI) on the light from the sensor module 440, and may determine the skin color type information (STI) of the user by using the information (SI) on the light and the type information (TI) stored in the memory 430.

At this time, the method for determining the skin color type (S1803) may utilize the method described in FIGS. 13 to 14. In other words, the skin color type information (STI) of the user may be determined by using the information (SI) on the light, which is obtained from the sensor module 440.

Meanwhile, the method for determining the skin color type (S1803) may include operations of: obtaining information on the skin color type from other modules (e.g., the camera module 475) included in the other electronic device 400-2 and/or the electronic device 400 or 400-1; and determining the skin color type information (STI) of the user by using the obtained information on the skin color type.

At (S1805), the processor 420 may determine a vitamin D synthesis time based on the determined skin color type information (STI). In other words, the processor 420 may estimate the time required for the vitamin D synthesis based on the skin color type information (STI). At this time, the processor 420 may determine (or calculate) the vitamin D synthesis time based on the skin color type information (STI) of the user, or may determine the vitamin D synthesis time by using data on the vitamin D synthesis time, which is stored in the memory 430.

The vitamin D synthesis time may mean the time required for synthesizing a daily required vitamin D according to the skin color type of the user. In addition, the vitamin D synthesis time may mean the time required for synthesizing a proper vitamin D according to the skin color type of the user.

At (S1807), the processor 420 may provide the user with the vitamin D synthesis-related information. The vitamin D synthesis-related information may be generated by using the vitamin D synthesis time. That is, the vitamin D synthesis-related information may refer to vitamin D synthesis guidance information according to the user's skin.

For example, the processor 420 may transmit the vitamin D synthesis-related information to an application related to the vitamin D, an application related to health information, and an application related to biometric information.

Meanwhile, the processor 420 may provide the user with both the vitamin D synthesis-related information and the UV exposure-related information described in FIG. 17.

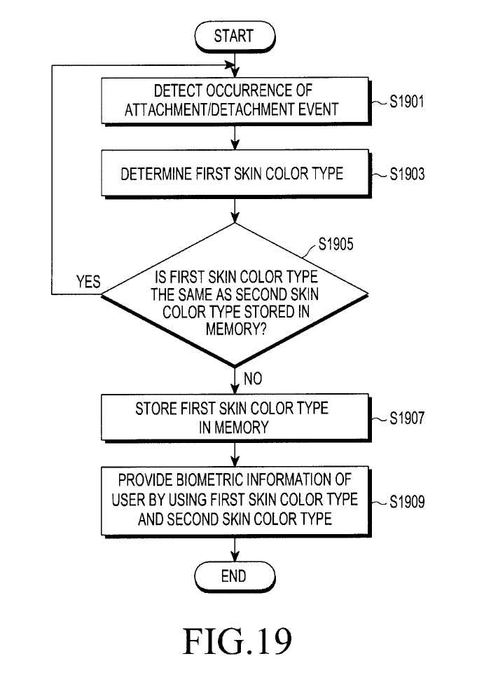

FIG. 19 is a flowchart illustrating a control method of the electronic device, according to various embodiments of the present disclosure.

Referring now to FIGS. 4, 6, and 19, at (S1901) the processor 420 may detect the occurrence of an event that is related to the user's skin. According to the embodiment, the occurrence of the event may be the occurrence of an attachment/detachment event (or an attachment/detachment event) (S1901).

The attachment/detachment event may refer to an operation or event in which the electronic device 400 or 400-1 is attached to (or comes into contact with), or detached (or separated) from, a user's body part (e.g., the skin). For example, in the case where the electronic device 400 or 400-1 is a watch, if the user wears, or takes off, the electronic device 400 or 400-1, the attachment/detachment event may occur.

According to the embodiment, the processor 420 may detect whether the electronic device 400 or 400-1 is attached to, or detached from, the user's skin by using the detection module 450. For example, if the attachment/detachment of the electronic device 400 or 400-1 with respect to the user's skin occurs, the detection module 450 may transmit an attachment/detachment signal (DI) to the processor 420

If an attachment/detachment event is detected, the processor 420 may identify whether or not the electronic device 400 or 400-1 comes into contact with the user's skin by using the detection module 450. In addition, if an attachment/detachment event is detected, the processor 420 may identify whether or not the sensor module 440 comes into contact with the user's skin by using the detection module 450. At this time, the sensor module 440 may include the detection module 450.

At (S1903), if the sensor module 440 comes into contact with the user's skin, the processor 420 may determine the first skin color type of the user by using the sensor module 440.

The processor 420 may receive information (SI) on the light from the sensor module 440, and may determine the first skin color type information (STI) of the user by using the information (SI) on the light and the type information (TI) stored in the memory 430 (S1903).

At this time, the method for determining the skin color type (S1903) may utilize the method described in FIGS. 11 to 14. That is, the first skin color type information (STI) of the user may be determined by using the information (SI) on the light, which is obtained from the sensor module 440.

Meanwhile, the method for determining the skin color type (S1903) may include operations of: obtaining information on the skin color type from other modules (e.g., the camera module 475) included in the other electronic device 400-2 and/or the electronic device 400 or 400-1; and determining the first skin color type information (STI) of the user by using the obtained information on the skin color type.

The processor 420 may compare the first skin color type information (STI) determined with the second skin color type of the user, which is stored in the memory 430.

The second skin color type refers to the skin color type of the user, which was predetermined and stored in the memory 430.

If the first skin color type information (STI) is the same as the second skin color type, it is determined that there is no change in the skin color type, so the processor 420 may not store the first skin color type information (STI) in the memory 430 (YES in S1905).

Meanwhile, if the first skin color type information (STI) is the same as the second skin color type, the processor 420 may store the first skin color type information (STI) in the memory 430. At this time, the processor 420 may store, in the memory 430, information on the time and/or the location, in which the first skin color type information (STI) has been measured, together with the first skin color type information (STI).

If the first skin color type information (STI) is not the same as the second skin color type (NO in S1905), it is determined that there is a change in the skin color type, so the processor 420 may store the first skin color type information (STI) in the memory 430 (S1907).

At this time, the processor 420 may store, in the memory 430, information on the time and/or the location in which the first skin color type information (STI) has been measured, together with the first skin color type information (STI).

In addition, in operation S1905, the processor 420 may update the skin color type stored in the memory, which is to be compared, with the first skin color type information (STI).

The processor 420 may receive the information on the time and/or the location in which the first skin color type information (STI) has been measured, from the GPS module 470.

At (S1909), the processor 420 may provide the user with health information (or biometric information) based on the difference between the first skin color type information (STI) and the stored skin color type.

In addition, the processor 420 provide the user with health information (or biometric information) by using health-related applications based on the difference between the first skin color type information (STI) and the stored skin color type.

The health information (or biometric information) means information about the user's health (or biometric conditions) that is determined by the difference between the first skin color type that is currently measured and the second skin color type that was measured in the past. For example, the health information (or biometric information) may contain the degree of skin moisture, the degree of skin aging, blood circulation information, and/or other information about the skin health and the user's health.

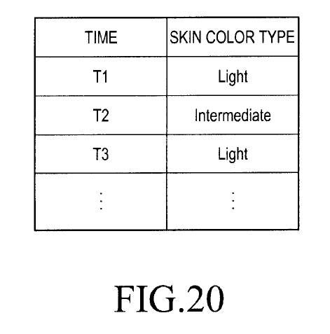

FIG. 20 is a table used to illustrate a control method of the electronic device described in FIG. 19.

Referring now to FIGS. 4, 6, 19, and 20, the memory 430 may store information related to the skin color type of the user.

The information related to the skin color type of the user may contain a table. The table may contain information on the time (TN, N is a natural number equal to, or more than, 1) at which the skin color type of the user has been measured and the skin color type corresponding to the measured time (TN).

Meanwhile, the table may contain information on the location where the skin color type of the user has been measured and the skin color type corresponding to the measured time.

Moreover, the processor 420 may store, in the memory 430, information on the time and/or the location in which the first skin color type information (STI) has been measured, together with the first skin color type information (STI).

If the first skin color type information (STI) is the same as the second skin color type, it is determined that there is no change in the skin color type, so the processor 420 may not store the first skin color type information (STI) in the memory 430 (YES in S1905 of FIG. 19).

According to the embodiment, in the case where the information on the skin color type, which is stored in the table, shows that the time is T2 and the skin color type is “Intermediate”, the processor 420 may not store the newly measured skin color type in the table if a newly measured skin color type is the same (Intermediate).

Meanwhile, if the first skin color type information (STI) is the same as the second skin color type, the processor 420 may store the first skin color type information (STI) in the memory 430. At this time, the processor 420 may store, in the memory 430, information on the time and/or the location, in which the first skin color type information (STI) has been measured, together with the first skin color type information (STI).

According to the embodiment, in the case where the information on the skin color type, which is stored in the table, shows that the time is T2 and the skin color type is “Intermediate”, the processor 420 may store the newly measured skin color type and the measurement time (T3) in the table if a newly measured skin color type is the same (Intermediate). In addition, the processor 420 may store both the measurement time and the measurement location.

If the first skin color type information (STI) is not the same as the second skin color type (NO in S1905), it is determined that there is a change in the skin color type, so the processor 420 may store the first skin color type information (STI) in the memory 430 (S1907). At this time, the processor 420 may store, in the memory 430, information on the time and/or the location in which the first skin color type information (STI) has been measured, together with the first skin color type information (STI).

According to this embodiment, in the case where the information on the skin color type, which is stored in the table, shows that the time is T2 and the skin color type is “Intermediate”, the processor 420 may store, in the table, the time (T3) at which the skin color type is newly measured and the skin color type (Light) corresponding thereto. Alternatively, the processor 420 may store both the measurement time and the measurement location.

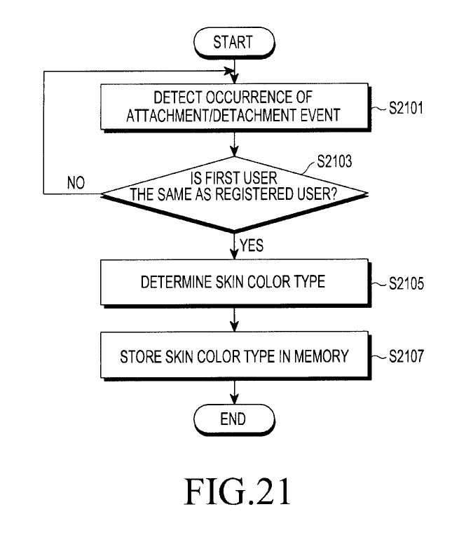

FIG. 21 is a flowchart illustrating a control method of the electronic device, according to various embodiments of the present disclosure.

Referring now to FIGS. 4, 6, and 21, the processor 420 may detect the occurrence of an event that is related to the skin of the first user. According to the embodiment, at (S2101), the occurrence of the event may be an attachment/detachment event (or the occurrence of an attachment/detachment event).

The occurrence of the attachment/detachment event may be implemented to be substantially identical, or similar, to the description of FIG. 19.

According to the embodiment, the processor 420 may detect whether the electronic device 400 or 400-1 is attached to, or detached from, the skin of the first user by using the detection module 450. For example, if the attachment/detachment of the electronic device 400 or 400-1 with respect to the skin of the first user occurs, the detection module 450 may transmit an attachment/detachment signal (DI) to the processor 420

If the attachment/detachment event is detected, the processor 420 may identify whether or not the electronic device 400 or 400-1 comes into contact with the skin of the first user by using the detection module 450. In addition, if the attachment/detachment event is detected, the processor 420 may identify whether or not the sensor module 440 comes into contact with the user's skin by using the detection module 450. At this time, the sensor module 440 may include the detection module 450.

At (S2103), the processor 420 may identify whether or not the first user is a registered (or predetermined) user by using the sensor module 440 (S2103).

According to the embodiment, the processor 420 may obtain biometric information from the skin of the first user by using the sensor module 440, and may compare the obtained biometric information with the biometric information stored in the memory 430 in order to identify whether or not the first user has been registered.

For example, the processor 420 may obtain the fingerprint of the first user by using the sensor module 440, and may determine whether or not the obtained fingerprint matches the fingerprint stored in the memory 430 in order to identify whether or not the first user has been registered.

Alternatively, the processor 420 may identify whether or not the first user is a registered (or predetermined) user by using the detection module 450 (S2103).

If the first user is a registered user, the processor 420 may determine the first skin color type of the first user (YES in S2103). However, if the first user is different from a registered user, the processor 420 may stop the operation of determining the skin color type of the first user (NO in S2103).

At (S2105), if the first user is a registered user, the processor 420 may determine the skin color type of the first user by using the sensor module 440.

The processor 420 may receive information (SI) on the light from the sensor module 440, and may determine the skin color type information (STI) of the first user by using the information (SI) on the light and the type information (TI) stored in the memory 430 (S2105).

At this time, the method for determining the skin color type (S2105) may utilize the method described in FIGS. 11 to 14. In other words, the skin color type information (STI) of the first user may be determined by using the information (SI) on the light, which is obtained from the sensor module 440.

Meanwhile, the method for determining the skin color type (S2105) may include operations of: obtaining information on the skin color type from other modules (e.g., the camera module 475) included in the other electronic device 400-2 and/or the electronic device 400 or 400-1; and determining the skin color type information (STI) of the first user by using the obtained information on the skin color type.

At (S2107), the processor 420 may store the determined skin color type of the first user in the memory 430. At this time, the processor 420 may store, in the memory 430, information on the time and/or the location in which the skin color type information (STI) has been measured, together with the skin color type information (STI) of the first user.

Each of the components of the electronic device according to the present disclosure may be implemented by one or more components and the name of the corresponding component may vary depending on a type of the electronic device. In various embodiments, the electronic device may include at least one of the above-described elements. Some of the above-described elements may be omitted from the electronic device, or the electronic device may further include additional elements. Further, some of the components of the electronic device according to the various embodiments of the present disclosure may be combined to form a single entity, and thus, may equivalently execute functions of the corresponding elements prior to the combination.

The apparatuses and methods of the disclosure can be implemented in hardware, and in part as firmware or via the execution of software or computer code in conjunction with hardware that is stored on a non-transitory machine readable medium such as a CD ROM, a RAM, a floppy disk, a hard disk, or a magneto-optical disk, or computer code downloaded over a network originally stored on a remote recording medium or a non-transitory machine readable medium and stored on a local non-transitory recording medium for execution by hardware such as by at least one processor, so that the methods described herein are loaded into hardware such as a general purpose computer, or a special processor or in programmable or dedicated hardware, such as an ASIC or FPGA.

As would be understood in the art, the computer, the processor, microprocessor, controller, control unit or the programmable hardware include memory components, e.g., RAM, ROM, Flash, etc., that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. In addition, an artisan understands and appreciates that a “processor”, “microprocessor” “controller”, or “control unit” constitute hardware in the claimed disclosure that contain circuitry, such as integrated circuitry, that is configured for operation. The control unit/controller may include a microprocessor or any suitable type of processing circuitry, such as one or more general-purpose processors (e.g., ARM-based processors), a Digital Signal Processor (DSP), a Programmable Logic Device (PLD), an Application-Specific Integrated Circuit (ASIC), a Field-Programmable Gate Array (FPGA), a Graphical Processing Unit (GPU), a video card controller, etc.

Under the broadest reasonable interpretation, the appended claims constitute statutory subject matter in compliance with 35 U.S.C. §101 and none of the elements are software per se.

Nor are the claims directed to Abstract ideas, and constitute statutory subject matter under 35 U.S.C. §101.

The definition of the terms “unit” or “module” as referred to herein are to be understood as constituting hardware circuitry such as a CCD, CMOS, SoC, AISC, FPGA, at least one processor or microprocessor (e.g. a controller or control unit) configured for a certain desired functionality, or a communication module containing hardware such as transmitter, receiver or transceiver, or a non-transitory medium comprising machine executable code that is loaded into and executed by hardware for operation, in accordance with statutory subject matter under 35 U.S.C. §101 and do not constitute software per se.

The term “module” as used herein may, for example, mean a unit including one of hardware, software or firmware in conjunction with hardware, or a combination of two or more of them. The “module” may be interchangeably used with, for example, the term “unit”, “logic”, “logical block”, “component”, or “circuit”. The “module” may be the smallest unit of an integrated component or a part thereof. The “module” may be the smallest unit that performs one or more functions or a part thereof. The “module” may be mechanically or electronically implemented. For example, the “module” according to the present disclosure may include at least one of an Application-Specific Integrated Circuit (ASIC) chip, a Field-Programmable Gate Arrays (FPGA), and a programmable-logic device for performing operations which has been known or are to be developed hereinafter.

According to various embodiments, at least some of the devices (for example, modules or functions thereof) or the method (for example, operations) according to the present disclosure may be implemented by a command stored in a computer-readable storage medium in a programming module form. When the command is executed by one or more processors (for example, the processor 120), the one or more processors may execute a function corresponding to the command. The computer-readable storage medium may, for example, be the memory 130.

The computer readable recoding medium may include a hard disk, a floppy disk, magnetic media (e.g., a magnetic tape), optical media (e.g., a Compact Disc Read Only Memory (CD-ROM) and a Digital Versatile Disc (DVD)), magneto-optical media (e.g., a floptical disk), a hardware device (e.g., a Read Only Memory (ROM), a Random Access Memory (RAM), a flash memory), and the like. In addition, the program instructions may include high class language codes, which can be executed in a computer by using an interpreter, as well as machine codes made by a compiler. The aforementioned hardware device may be configured to operate as one or more software modules in order to perform the operation of the present disclosure, and vice versa.

The programming module according to the present disclosure may include one or more of the aforementioned components or may further include other additional components, or some of the aforementioned components may be omitted. Operations executed by a module, a programming module, or other component elements according to various embodiments of the present disclosure may be executed sequentially, in parallel, repeatedly, or in a heuristic manner. Further, some operations may be executed according to another order or may be omitted, or other operations may be added.

According to various embodiments of the present disclosure, a storage medium may store instructions that are executed by one or more processors to allow the one or more processors to perform operations of: obtaining a message from a sender; identifying a receiver of the message; converting the message based on the first relationship information between the sender and the receiver and the second relationship information between the receiver and the electronic device; and outputting the converted message.

The embodiments disclosed herein are provided merely to easily describe technical details of the present disclosure and to help the understanding of the present disclosure, and are not intended to limit the scope of the present disclosure. Therefore, it should be construed that all modifications and changes or modified and changed forms based on the technical idea of the present disclosure fall within the scope of the present disclosure.

What is claimed is:

1. A control method of an electronic device, the method comprising:
detecting an occurrence of an event related to at least a part of a user's body;
obtaining information provided by a light according to the detected event from a sensor module that is functionally connected with the electronic device; and
performing a function corresponding to the detected event by using information corresponding to the obtained information provided the light from among type information stored in a memory.

2. The method according to claim 1, wherein the obtaining of the information provided by the light from the sensor module is based on a first optical signal that is output from a light-emitting unit of the sensor module and a second optical signal that is received by alight-receiving unit of the sensor module after the first optical signal passes through a user's skin.

3. The method according to claim 1, wherein the type information used for performing the function corresponding to the detected event includes at least one of a melanin index conversion information or a color space value information.

4. The method according to claim 1, wherein the detecting of the occurrence of an event includes at least one processor sending, to the sensor module, a control signal for controlling an activation degree of the sensor module based on the detected event.

5. The method according to claim 1, wherein when the detected event is an attachment/detachment event or an execution of a heart rate measurement application, the performing of the function corresponding to the detected event includes controlling a current intensity of a light-emitting unit of the sensor module.

6. The method according to claim 1, wherein when the detected event is the occurrence of updating at least one of a season information or a weather information, the performing of the function corresponding to the detected event includes providing at least one of UV exposure-related information or vitamin D synthesis-related information with respect to a user's skin.

7. The method according to claim 1, wherein when the detected event is an execution of a camera application, the performing of the function corresponding to the detected event includes generating skin color correction information for the user's skin.

8. The method according to claim 1, wherein the obtaining of the information regarding the light from the sensor module comprises:
determining whether or not the sensor module comes into contact with a user's skin; and
obtaining the information provided by the light if the sensor module comes into contact with the user's skin.

9. The method according to claim 1, further comprising:
determining a skin color type of the user based on the information provided by the light; and
storing the skin color type in the memory.

10. An electronic device comprising:
a processor that detects an occurrence of an event that is related to at least a part of a user's body and controls the electronic device;
a memory that stores type information; and
a sensor module, which is controlled by the processor, that obtains information provided by a light that passes through a user's skin, wherein the processor performs a function corresponding to the detected event by using information corresponding to the obtained information provided by the light from among the type information stored in the memory.

11. The electronic device according to claim 10, wherein the sensor module comprises:
a light-emitting unit that outputs a first optical signal; and
a light-receiving unit that receives a second optical signal comprised of the first optical signal after passage through the user's skin, wherein the sensor modules ends the information provided by the light to the processor based on the first optical signal and the second optical signal.

12. The electronic device according to claim 10, wherein the type information used to perform the function corresponding to the detected event includes at least one of a melanin index conversion information or a color space value information.

13. The electronic device according to claim 10, wherein the processor sends a control signal to the sensor module for controlling an activation degree of the sensor module based on the detected event.

14. The electronic device according to claim 10, wherein when the event is an attachment/detachment event or an execution of a heart rate measurement application, the function corresponding to the event is controlling a current intensity of a light-emitting unit of the sensor module.

15. The electronic device according to claim 10, wherein the event is an occurrence of updating at least one of season information or weather information, the function corresponding to the detected event comprises providing at least one of UV exposure-related information, or vitamin D synthesis-related information with respect to the user's skin.

16. The electronic device according to claim 10, wherein when the event is an execution of a camera application, the function corresponding to the detected event includes a generation of skin color correction information for the user's skin.

17. The electronic device according to claim 10, further comprising a detection module that determines whether or not the sensor module comes into contact with the user's skin, wherein the processor obtains the information regarding the light from the sensor module according to a determination result of the detection module.

18. The electronic device according to claim 10, wherein the processor determines a skin color type of the user based on the information regarding the light from the sensor module, and stores the skin color type in the memory.

19. A control method of an electronic device, the method comprising:
detecting an occurrence of an event that is related to a skin of a first user;
identifying whether or not a sensor module comes into contact with the skin of the first user by a detection module according to the detected event;
obtaining, from the sensor module, information regarding a light that passes through a user's skin in response to the sensor module being in contact with the skin of the first user;
generating a first skin color type information corresponding to the obtained information regarding the light from among type information stored in a memory;
comparing the first skin color type information with a second skin color type information stored in the memory; and
storing the first skin color type information in the memory according to a result of comparing the first skin color type information with a second skin color type information stored in the memory.

20. The method according to claim 19, wherein the identifying of the contact by the detection module comprises determining whether or not the first user is the same as a second user who is predetermined.

21. The method according to claim 19, further comprising providing health status information of the first user based on the first skin color type information and the second skin color type information.

22. A control method of an electronic device, the method comprising:
detecting an occurrence of an event that uses a skin color type of a first user, which is predetermined;
obtaining the skin color type of the first user; and
performing a function corresponding to the detected event by using the obtained skin color type of the first user.

23. The method according to claim 22, wherein the obtaining of the skin color type of the first user comprises obtaining the skin color type of the first user from other electronic devices.

24. The method according to claim 22, wherein the obtaining of the skin color type of the first user comprises:
analyzing an image that is obtained from a camera module included in the electronic device; and
determining the skin color type of the first user by using a result of the analyzing of the image that is obtained from a camera module.
